(19) United States
(12) Patent Application Publication
(10) Pub. No.: US 2005/0219239 A1
(43) Pub. Date: Oct. 6, 2005

(54) Method and apparatus for processing three-dimensional images

(75) Inventors: Ken Mashitani, Neyagawa City (JP); Goro Hamagishi, Toyonaka City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/086,493

(22) Filed: Mar. 23, 2005

(30) Foreign Application Priority Data
Mar. 31, 2004 (JP) 2004-104148

(51) Int. Cl. G06T 15/40; G06F 15/80; G06T 15/00

(52) U.S. Cl. 345/419; 345/422; 345/505

(57) ABSTRACT

A camera placement determining unit determines a position at which a real, camera is placed in an object space, based on a z-value acquired in a frame immediately preceding a current frame and a user's appropriate parallax. After a projection processing, a parallax image generator generates parallax images based on viewpoint images. The z-value is acquired, in the immediately preceding frame, by at least one real camera positioned by the camera placement determining unit. Using this z-value in the current frame, the high-speed processing of three-dimensional images as a whole can be achieved.

### BACKGROUND OF THE INVENTION

1. Field of the Invention

The present invention relates to a stereo image processing technology, and it particularly relates to method and apparatus for producing stereo images based on parallax images.

2. Description of the Related Art

In recent years, inadequacy of network infrastructure has often been an issue, but in this time of transition toward broadband age, it is rather the inadequacy in the kind and number of contents utilizing broadband that is drawing more of our attention. Images have always been the most important means of expression, but most of the attempts so far have been at improving the quality of display or data compression ratio. In contrast, technical attempts at expanding the possibilities of expression itself seem to be falling behind.

Under such circumstances, three-dimensional image display (hereinafter referred to simply as “3D display” also) has been studied in various manners and has found practical applications in somewhat limited markets, which include uses in the theater or ones with the help of special display devices. In the near future, it is expected that the research and development in this area may further accelerate toward the offering of contents full of realism and presence and the times may come when individual users enjoy 3D display at home.

Even today, individual users, for instance, can enjoy vivid and impressive three-dimensional images that show objects flying out toward them. For example, in a racing game, the user can enjoy a three-dimensional game in which the user operates an object, such as a car, displayed right before his/her eyes and has it run within a virtual three-dimensional space where the object resides (hereinafter referred to simply as “object space”) in competition with the other cars operated by the other players or the computer.

Thus technologies for 3D display are being widely used today and are expected to find wider use in the years ahead. In fact, a variety of new 3D display modes are being proposed. For example, Reference (1) in the following Related Art List discloses a technology for displaying three-dimensionally a selected partial image in a two-dimensional image.

Related Art List

(1) Japanese Patent Application Laid-Open No. 11-39507.

According to the technology introduced in Reference (1), a desired portion of a plane image can be displayed three-dimensionally. This particular technology, however, is not intended to realize a high speed for the 3D display processing as a whole. A new methodology need be invented to realize a high speed therefor.

### SUMMARY OF THE INVENTION

The present invention has been made in view of the foregoing circumstances and an object thereof is to provide method and apparatus for processing three-dimensional images capable of performing the 3D display processing as a whole at high speed.

A preferred mode of carrying out the present invention relates to a three-dimensional image processing apparatus. This apparatus is a three-dimensional image processing apparatus that displays an object three-dimensionally based on a plurality of viewpoint images corresponding to different viewpoints, and the apparatus comprises: a depth value acquiring unit which acquires a range of calculation region in a depth direction in a virtual space that contains the object to be displayed three-dimensionally; a viewpoint placement unit which places a plurality of different viewpoints in the virtual space based on the acquired range of calculation region in the depth direction; and a parallax image generator which generates parallax images based on viewpoint images from the plurality of different viewpoints.

The “3D display” indicates displaying three-dimensional images. The “three-dimensional images” are images displayed with the stereoscopic effect, and their entities are “parallax images” in which parallax is given to a plurality of images. The parallax images are generally a set of a plurality of two-dimensional images. Each of images that constitute the parallax images is a “viewpoint image” having viewpoints corresponding respectively to parallax images. That is, a parallax image is constituted by a plurality of viewpoint images. The “range of calculation region” is an area in a virtual space in which a predetermine calculation is performed to display an object three-dimensionally.

The “parallax” is a parameter to produce a stereoscopic effect and various definitions are possible. As an example, it can be represented by a difference between coordinates values that represent the same position among the viewpoint images. Hereinafter, the present specification follows this definition unless otherwise stated.

According to this mode of carrying out the present invention, a plurality of different viewpoints are placed in a virtual space, based on a range of calculation region in the depth direction, so that effective parallax images can be obtained and appropriate 3D display can be realized.

This apparatus may further comprise a viewpoint temporary positioning unit which temporarily positions at least one viewpoint in the virtual space, wherein the depth value acquiring unit may acquire the range of calculation region in the depth direction based on the temporarily positioned viewpoint. The viewpoint temporary positioning unit may position one viewpoint in the virtual space.

The viewpoint temporary positioning unit may position the viewpoint in the virtual space in such a manner as to have a field of view that contains a field of view of the plurality of different viewpoints placed by the viewpoint placement unit. Based on the range of calculation region in the depth direction acquired by the depth value acquiring unit, the viewpoint placement unit may place, in addition to the at least one viewpoint temporarily positioned by the viewpoint temporary positioning unit, two different viewpoints in the virtual space such that the viewpoint temporarily positioned by the viewpoint temporary positioning unit comes to a center of the two different viewpoints placed by the viewpoint placement unit. The viewpoint positioning unit may place a plurality of viewpoints on both sides outwardly of the two different viewpoints so that a distance between viewpoints is equal to an interval between the two different viewpoints.

The depth value acquiring unit may acquire the range of calculation region in the depth direction at a resolution lower than that of the viewpoint images. The depth value acquiring unit may acquire the range of calculation region in the depth direction, by using an object which corresponds to the object to be displayed three-dimensionally and which has a small amount of data. According to this mode of carrying out the present invention, a processing amount required for acquiring the range of calculation region in the depth direction is reduced, so that a high speed processing as a whole can be realized.

The depth value acquiring unit may acquire the range of calculation region in the depth direction from at least one viewpoint among the plurality of viewpoints placed by the viewpoint placement unit. The depth value acquiring unit may acquire ranges of calculation region in depth directions from at least two viewpoints among the plurality of viewpoints placed by the viewpoint placement unit and may generate one range of calculation region in the depth direction by combining the ranges of calculation region in the respective depth directions.

The apparatus may further comprise a depth value use/nonuse determining unit which determines whether the range of calculation region in the depth direction acquired by the depth value acquiring unit can be used or not, wherein when it is decided by the depth value use/nonuse determining unit that the range of calculation region in the depth direction cannot be used, the parallax image generator may generate a two-dimensional image having no parallax. The apparatus may further comprise a depth value use/nonuse determining unit which determines whether the range of calculation region acquired by the depth value acquiring unit can be used or not, wherein when it is decided by the depth value use/nonuse determining unit that the range of calculation region cannot be used, the viewpoint placement unit may arrange the plurality of different viewpoints in such a manner as to generate parallax images with weaker parallax than that of the parallax images generated previously.

The apparatus may further comprise a depth value use/nonuse determining unit which determines whether the range of calculation region in the depth direction acquired by the depth value acquiring unit can be used or not, wherein when it is decided by the depth value use/nonuse determining unit that the range of calculation region in the depth direction cannot be used, the depth value acquiring unit may acquire the range of calculation region in the depth direction, using a front projection plane and a back projection plane.

The apparatus may further comprise: a motion estimation unit which detects a motion state of the object and estimates a state of future motion of the object based on a detected result; and a variation estimating unit which estimates, based on the motion state of the object estimated by the motion estimation unit, a variation of a predetermined region that contains the object, wherein the viewpoint placement unit may arrange the plurality of different viewpoints in the virtual space, based on the variation of a predetermined region estimated by the variation estimating unit.

The apparatus may further comprise a calculation selective information acquiring unit which acquires selective information for calculation to be included or not in the range of calculation region for each object, wherein when the selective information for calculation not to be included in the range of calculation region is acquired by the calculation selective information acquiring unit, the depth value acquiring unit may disregard an object which is decided not to be included and may acquire a range of calculation region in the depth direction from another object.

Another preferred mode of carrying out the present invention relates to a method for processing three-dimensional images. This method includes: acquiring a range of calculation region in a depth direction in a virtual space that contains an object to be displayed three-dimensionally; placing a plurality of different viewpoints in the virtual space based on the acquired range of calculation region in the depth direction; and generating parallax images based on viewpoint images from the plurality of different viewpoints.

It is to be noted that any arbitrary combination of the above-described components and expressions mutually replaced by among a method, an apparatus, a system, a recording medium, a computer program and so forth are all effective as and encompassed by the modes of carrying out the present invention.

### BRIEF DESCRIPTION OF THE DRAWINGS

FIG. 1 illustrates schematically a basic representation space in relation to a screen surface.

FIG. 2 schematically illustrates a calculation region and a hidden surface region which are identified by a temporary camera.

FIG. 3 illustrates how a 3D display of objects is realized by a three-dimensional image processing apparatus according to a first embodiment.

FIG. 4 illustrates a structure of a three-dimensional image processing apparatus according to a first embodiment of the present invention.

FIG. 5A and FIG. 5B show respectively a left-eye image and a right-eye image displayed by a three-dimensional sense adjusting unit of a three-dimensional image processing apparatus.

FIG. 6 shows a plurality of objects, having different parallaxes, displayed by a three-dimensional sense adjusting unit of a three-dimensional image processing apparatus.

FIG. 7 shows an object, whose parallax varies, displayed by a three-dimensional sense adjusting unit of a three-dimensional image processing apparatus.

FIG. 8 shows a table to be utilized in a simplified determination of parallax and basic representation space.

FIG. 9 illustrates a world-coordinate system used in a three-dimensional image processing.

FIG. 10 illustrates a model coordinate system used in a three-dimensional image processing.

FIG. 11 illustrates a camera coordinate system used in a three-dimensional image processing.

FIG. 12 illustrates a view volume used in a three-dimensional image processing.

FIG. 13 shows a coordinate system after perspective transformation has been performed on the volume of FIG. 12.

FIG. 14 shows a relationship among a camera's angle of view, an image size and a parallax when appropriate parallax is to be achieved.

FIG. 15 shows a positional relationship in an image shooting system that realizes the state of FIG. 14.

FIG. 16 shows a positional relationship in an image shooting system that realizes the state of FIG. 14.

FIG. 17 illustrates a screen coordinate system used in a three-dimensional image processing.

FIG. 18 shows a flow of processing by a three-dimensional image processing apparatus according to a first embodiment of the present invention.

FIG. 19 illustrates a structure of a three-dimensional image processing apparatus according to a second embodiment.

FIG. 20 shows a flow of processing by a three-dimensional image processing apparatus according to a second embodiment of the present invention.

FIG. 21 illustrates a structure of a three-dimensional image processing apparatus according to a third embodiment of the present invention.

FIG. 22 shows a flow of processing by a three-dimensional image processing apparatus according to a third embodiment of the present invention.

FIG. 23 illustrates a structure of a three-dimensional image processing apparatus according to the first modification.

FIG. 24 illustrates a structure of a three-dimensional image processing apparatus according to the second modification.

FIG. 25 shows a flow of processing by a three-dimensional image processing apparatus according to the third modification.

FIG. 26 schematically illustrates how a region of calculation in the depth direction is acquired using angles according to the fourth modification.

FIG. 27 shows the positions of four cameras of four eyes according to the fifth modification.

FIG. 28 shows a positional relationship among a temporary camera and real cameras according o the sixth modification.

FIG. 29 illustrates a structure of a three-dimensional image processing apparatus according to the seventh modification.

FIG. 30 shows a flow of processing by a three-dimensional image processing apparatus according to the ninth modification.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

The three-dimensional image processing apparatuses to be hereinbelow described in the first to third embodiments of the present invention are each an apparatus for generating parallax images based on viewpoint images from given viewpoints in an object space. By producing such images on a 3D image display unit, such an apparatus realizes a 3D image representation providing impressive and vivid 3D images with objects therein flying out toward a user. For example, in a racing game, a player can enjoy a 3D game in which the player operates an object, such as a car, displayed right before his/her eyes and has it run within an object space in competition with the other cars operated by the other players or the computer.

When producing a 3D display of such an object, this apparatus adjusts the distance or interval between viewpoints set in an object space and other parameters frame by frame. A frame is the smallest unit that constitutes a moving image. Through the adjustment of the intervals between viewpoints and other parameters frame by frame, parallax images can be created according to the changes in the movement or condition of an object, and thus an optimum 3D display can be produced based thereon.

In the creation of parallax images frame by frame, the parallax, if given too much, can cause problems. In fact, certain viewers of 3D images (hereinafter referred to simply as “user”) may sometimes complain of having a slightly uncomfortable feeling. With this apparatus, therefore, the parallax is optimized according to instructions given by the user.

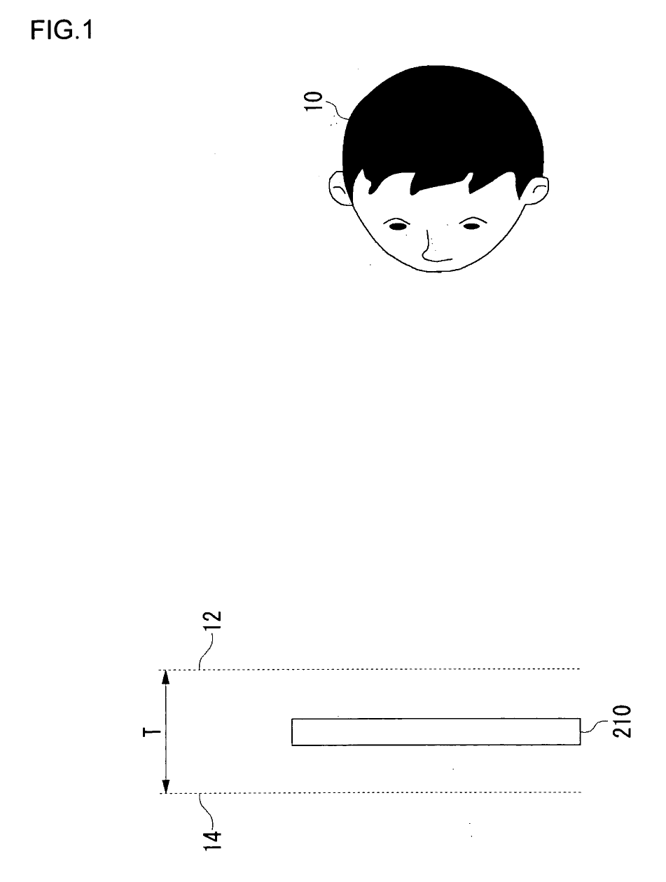

FIG. 1 illustrates schematically a basic representation space T in relation to a screen surface 210. Here, the basic representation space T is a space in which the user 10 can find appropriate parallax. In other words, when an object exists closer to the user than a front plane 12 of the basic representation space or farther than the rear plane 14 thereof, the user may have a sense of discomfort with what he/she sees. Hence, a 3D image processing apparatus according to the preferred embodiments of the present invention provides a 3D display of an object within the basic representation space T. And the range of a basic representation space T is set by each individual user.

### First Embodiment

A first embodiment of the present invention will be outlined below. According to the first embodiment, a viewpoint, such as a camera, is disposed temporarily in an object space. The range of calculation area in the depth direction for an object to be displayed three-dimensionally can be obtained by the camera thus placed temporarily (hereinafter referred to simply as “temporary camera”). In obtaining this range of calculation area in the depth direction, an apparatus according to the first embodiment uses a known algorithm of hidden surface removal which is called the z-buffer method. The z-buffer method is a technique such that when the z-values of an object are to be stored for each pixel, the z-value already stored is overwritten by any z-value closer to the viewpoint on the Z axis. The range of calculation area in the depth direction is specified by obtaining the maximum z-value and the minimum z-value among the z-values thus stored for each pixel (hereinafter referred to simply as “maximum z-value” and “minimum z-value”, respectively). According to the preferred embodiments, the z-values of an object are obtained in positions corresponding to the pixels separated by the line segments in the X-axis direction and the Y-axis direction.

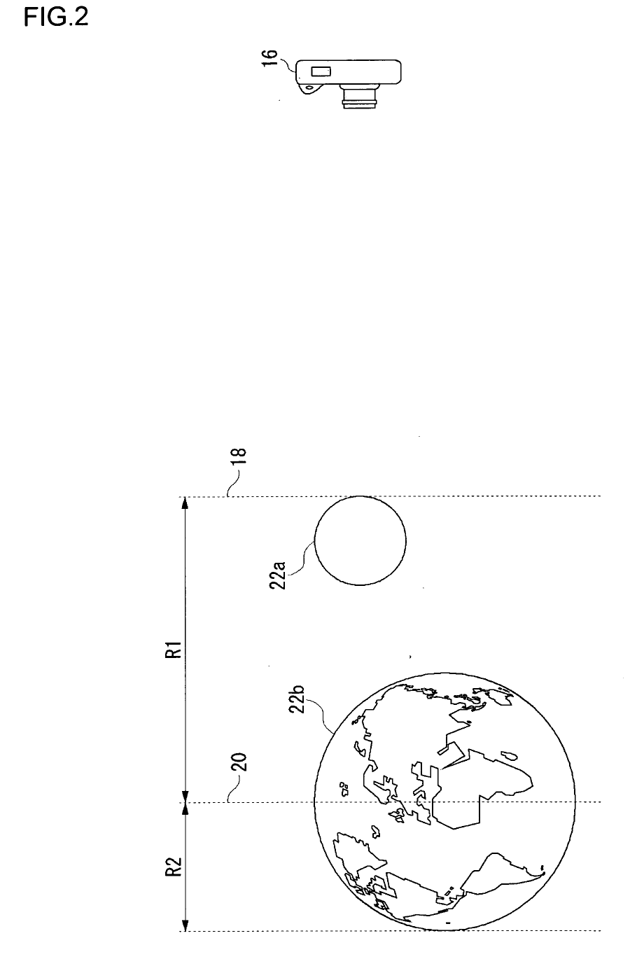

FIG. 2 schematically illustrates a calculation region R1 and a hidden surface region R2 which are identified by a temporary camera 16. Placed in an object space are a temporary camera 16, a first object 22a and a second object 22b. The calculation region R1 is a region which is subjected to the calculation of camera parameters for a real camera, to be discussed later, which generates parallax images. Typically, the calculation region R1 corresponds to a region where the visible surfaces of objects to be displayed three-dimensionally exist. As already mentioned, the range of the calculation area R1 in the depth direction is specified by obtaining the maximum z-value and the minimum z-value among the z-values stored for each pixel. On the other hand, the hidden surface region R2 is a region excluded from the calculation to obtain camera parameters for a real camera, to be discussed later. Typically, the hidden surface region R2 is a region that is in back of the calculation region R1 as seen from a viewpoint, such as a temporary camera, where the invisible surfaces of objects hidden behind the visible surfaces thereof exist. Here, the first object 22a and the second object 22b are collectively referred to as an object 22. As a result of obtaining the range of a calculation region in the depth direction from a temporary camera 16 by the z-buffer method, the depth of the closest calculation region plane 18 of the calculation region R1 is defined by the minimum z-value whereas the depth of the farthest calculation region plane 20 thereof is defined by the maximum z-value. The hidden surface region R2 is a region that is shaded by the above-mentioned z-buffer method.

Based on the thus obtained maximum z-value and minimum z-value, this apparatus determines an arrangement of a plurality of cameras, for example two cameras, (hereinafter referred to simply as “real cameras”) for acquiring parallax images and placing the two real cameras in their respective positions in an object space. In doing so, the two real cameras are placed in such a manner that the temporary camera having been placed temporarily is positioned at the center of the arrangement, for instance, at a midway point between the two real cameras. Furthermore, in determining the arrangement of these two real cameras, this apparatus takes appropriate parallax for the user into consideration.

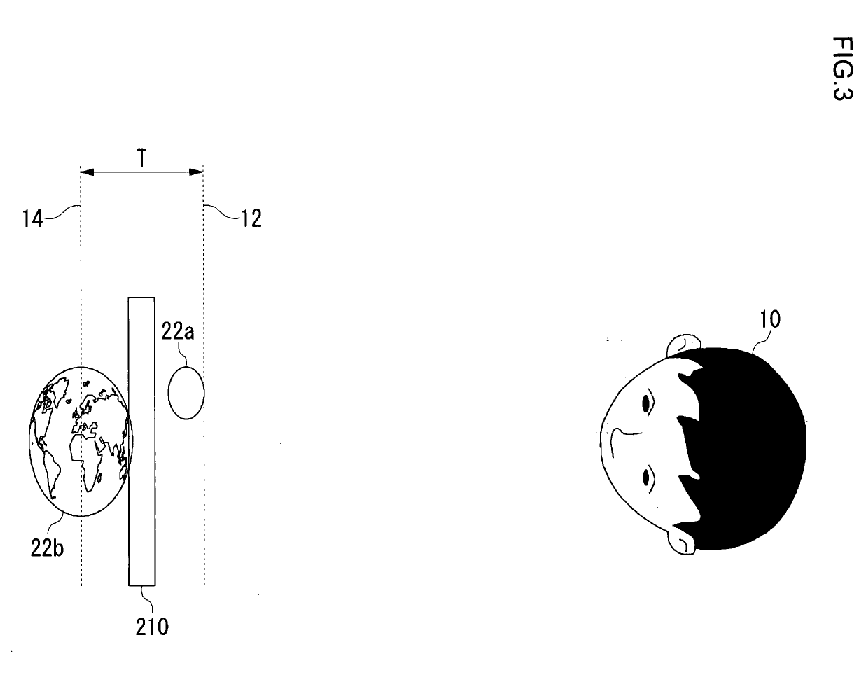

Thus this apparatus arranges two real cameras, performs a projection processing, to be described later, for each camera on an object to be displayed three-dimensionally, acquires viewpoint images and generates parallax images. FIG. 3 illustrates how a 3D display of objects 22 is realized by a three-dimensional image processing apparatus according to the first embodiment. The same reference numbers are used for the same parts as in FIG. 1 and their repeated explanation will be omitted. As is shown in FIG. 3, a 3D display is carried out in a manner such that the previously obtained calculation region is held within a depth range between the front basic representation space plane 12 and a rear basic representation space plane 14 of the basic representation space T.

As described above, this apparatus generates parallax images frame by frame. For example, when there are more than a few real cameras disposed and thus there is much calculation to be done to generate parallax images, the following processings may be performed to shorten the time for obtaining z-values by the temporary camera:

1) The z-values are obtained at a resolution lower than that of viewpoint images for each real camera.

2) The z-values corresponding to objects to be displayed three-dimensionally are obtained, using objects having a small amount of data. In this case, another object space may be prepared for the acquisition of z-values, and the z-values may be obtained by placing the objects in this object space.

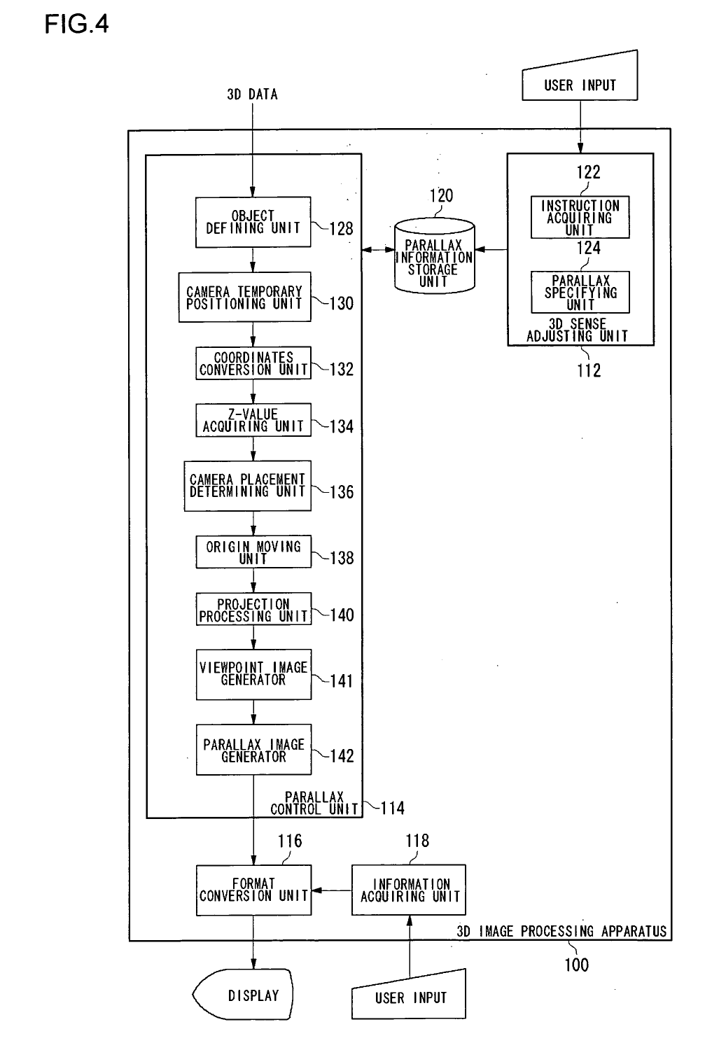

FIG. 4 illustrates a structure of a three-dimensional image processing apparatus 100 according to the first embodiment of the present invention. This apparatus provides a 3D display of an object based on a plurality of viewpoint images corresponding to different viewpoints. This three-dimensional image processing apparatus 100 includes a three-dimensional sense adjusting unit 112 which adjusts the three-dimensional effect and sense according to a user response to an image displayed three-dimensionally, a parallax information storage unit 120 which stores an appropriate parallax specified by the three-dimensional sense adjusting unit 112, a parallax control unit 114 which reads out an appropriate parallax from the parallax information storage unit 120 and generates parallax images having the appropriate parallax from 3D data, an information acquiring unit 118 which has a function of acquiring hardware information on a display unit and also acquiring a stereo display scheme, and a format conversion unit 116 which changes the format of the parallax images generated by the parallax control unit 114 based on the information acquired by the information acquiring unit 118. Here, the hardware information includes information on hardware, such as the display unit itself, and information on other factors, such as the distance between the user and the display unit. The 3D data for rendering the objects and space are inputted to the three-dimensional image processing apparatus 100. The 3D data are, for instance, data on objects and space written in a world-coordinate system.

In terms of hardware, the above-described structure can be realized by a CPU, a memory and other LSIs of an arbitrary computer, whereas in terms of software, it can be realized by programs which have GUI function, parallax controlling function and other functions or the like, but drawn here are function blocks that are realized in cooperation with those. Thus, it is understood by those skilled in the art that these function blocks can be realized in a variety of forms such as hardware only, software only or combination thereof, and the same is true as to the structure in what is to follow.

The three-dimensional sense adjusting unit 112 includes an instruction acquiring unit 122 and a parallax specifying unit 124. The instruction acquiring unit 122 acquires an instruction when it is given by the user who specifies a range of appropriate parallax in response to an image displayed three-dimensionally. Based on this range of appropriate parallax, the parallax specifying unit 124 identifies the appropriate parallax when the user uses this display unit. The appropriate parallax is expressed in a format that does not depend on the hardware of a display unit. And stereo vision matching the physiology of the user can be achieved by realizing the appropriate parallax. The specification of a range of appropriate parallax by the user as described above is accomplished via a GUI (graphical user interface), not shown, the detail of which will be discussed later.

The parallax control unit 114 includes an object defining unit 128 which defines objects in a virtual space based on 3D data, a camera temporary positioning unit 130 which temporarily positions a temporary camera in an object space, a coordinates conversion unit 132 which converts the coordinates defined on the system of world coordinates in reference to the temporary camera positioned temporarily by the camera temporary positioning unit 130 into those on a perspective coordinate system, a z-value acquiring unit 134 which acquires z-values by the z-buffer method when a coordinate conversion has been done by the coordinates conversion unit 132, a camera placement determining unit 136 which calculates camera parameters, such as camera interval, according to the z-values acquired by the z-value acquiring unit 134 and the appropriate parallax stored in the parallax information storage unit 120 and arranges two real cameras in the object space based thereon, an origin moving unit 138 which performs an origin movement such that the real cameras become the origin of the camera coordinate system, a projection processing unit 140 which performs a projection processing to be described later, a viewpoint image generator 141 which generates viewpoint images by performing a conversion processing into a screen coordinate system after the projection processing, and a parallax image generator 142 which generates parallax images based on a plurality of viewpoint images thus generated. The camera placement determining unit 136 places two real cameras in the present embodiment, but may arrange three or more cameras. The details of the components of a parallax control unit 114 will be described later.

The information acquiring unit 118 acquires information which is inputted by the user. The “information” includes the number of viewpoints for 3D display, the system of a stereo display apparatus such as space division or time division, whether shutter glasses are used or not, the arrangement of viewpoint images in the case of a multiple-eye system, whether there is any arrangement of viewpoint images with inverted parallax among the parallax images, and the result of head tracking. It is to be noted here that the result of head tracking, as an exception, is inputted directly to the camera placement determining unit 136 via a route not shown and is processed there.

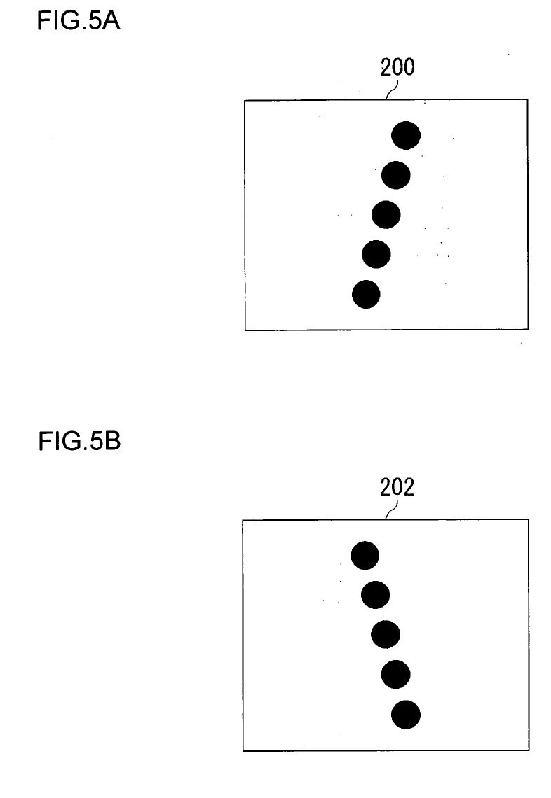

The user's specification of the range of appropriate parallax is done as follows. FIG. 5A and FIG. 5B show respectively a left-eye image 200 and a right-eye image 202 displayed in a certain process of appropriate parallax by a three-dimensional sense adjusting unit 112 of a three-dimensional image processing apparatus 100.

Being “nearer-positioned” means a state where there is given a parallax in a manner such that stereovision is done in front of a surface (hereinafter referred to as “optical axis intersecting surface” also) at a sight line of two cameras placed at different positions, namely, at an intersecting position of optical axes (hereinafter referred to as “optical axis intersecting position” also). Conversely, being “farther-positioned” means a state where there is given a parallax in a manner such that stereovision is done behind the optical axis intersecting surface. The larger the parallax of a nearer-positioned object, it is perceived closer to a user whereas the larger the parallax of a farther-positioned object, it is seen farther from the user. Unless otherwise stated, the parallax is such that a plus and a minus do not invert around by between nearer position and farther position and both the positions are defined as nonnegative values and the nearer-positioned parallax and the farther-positioned parallax are both zeroes at the optical axis intersecting surface.

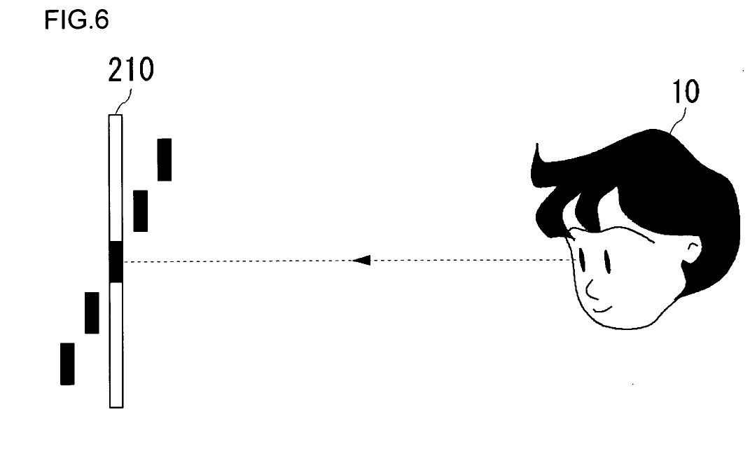

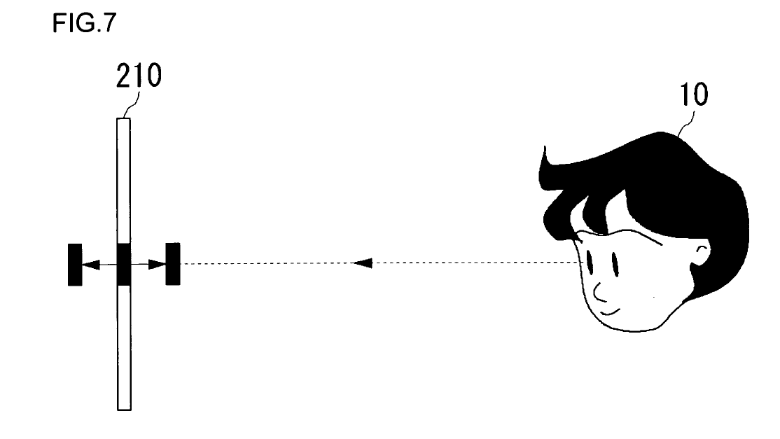

FIG. 6 shows schematically a sense of distance perceived by a user 10 when these five black circles are displayed. In FIG. 6, the five black circles with different parallaxes are displayed all at once or one by one, and the user 10 performs inputs indicating whether the parallax is permissible or not. In FIG. 7, on the other hand, the display itself is done in a single black circle, whose parallax is changed continuously. When the parallax reaches a permissible limit in each of the farther and the nearer placement direction, a predetermined input instruction from a user 10 is given, so that an allowable parallax can be determined. The instruction may be given using any known technology, which includes ordinary key operation, mouse operation, voice input and so forth.

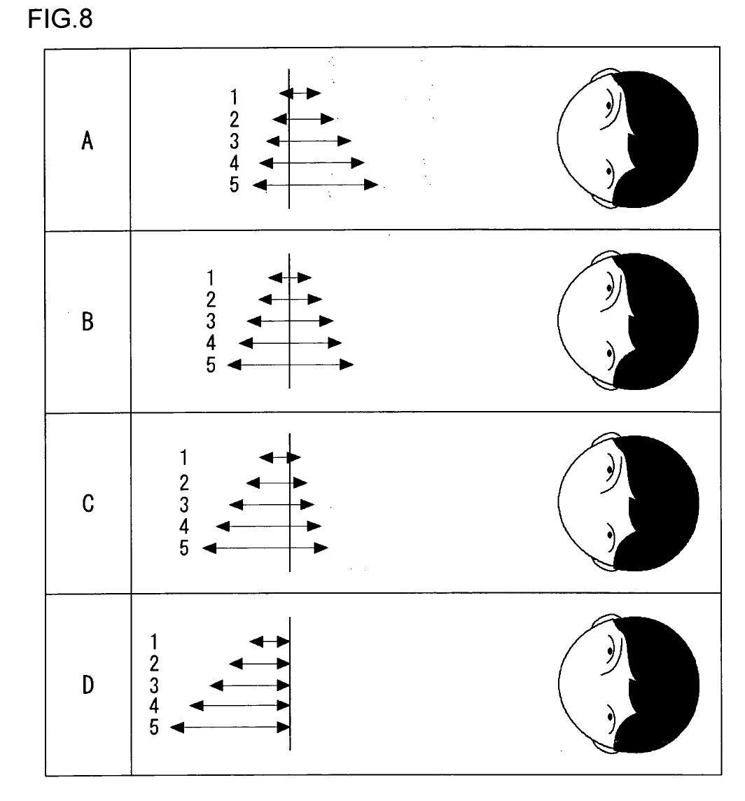

Moreover, the determination of parallax may be carried out by a simpler method. Similarly, the determination of the setting range of basic representation space may be carried out by a simple method, too. FIG. 8 shows a table to be used in a simplified determination of parallax and basic representation space. The setting range of basic representation space is divided into four ranks of A to D from the setting with more of nearer-position space to the setting with only farther-position space, and moreover each of the parallaxes is divided into five ranks of 1 to 5. Here, the rank of 5A is to be selected, for instance, if the user prefers a strongest stereo effect and desires a most protruding 3D display. And it is not absolutely necessary that the rank be determined while checking on a 3D display, but the buttons for determining the rank only may be displayed. There may be a button for checking the stereo effect by the side of them, and pushing it may produce a display of an image for checking the stereo effect.

In both cases of FIG. 6 and FIG. 7, the instruction acquiring unit 122 can acquire an appropriate parallax as a range thereof, so that the limit parallaxes on the nearer-position side and the farther-position side are determined. A nearer-positioned maximum parallax is a parallax corresponding to the closeness which the user permits for a point perceived closest to himself/herself, and a farther-positioned maximum parallax is a parallax corresponding to the distance which the user permits for a point perceived farthest from himself/herself. Generally, however, the nearer-positioned maximum parallax is more important to the user for physiological reasons, and therefore the nearer-positioned maximum parallax only may sometimes be called the limit parallax hereinbelow.

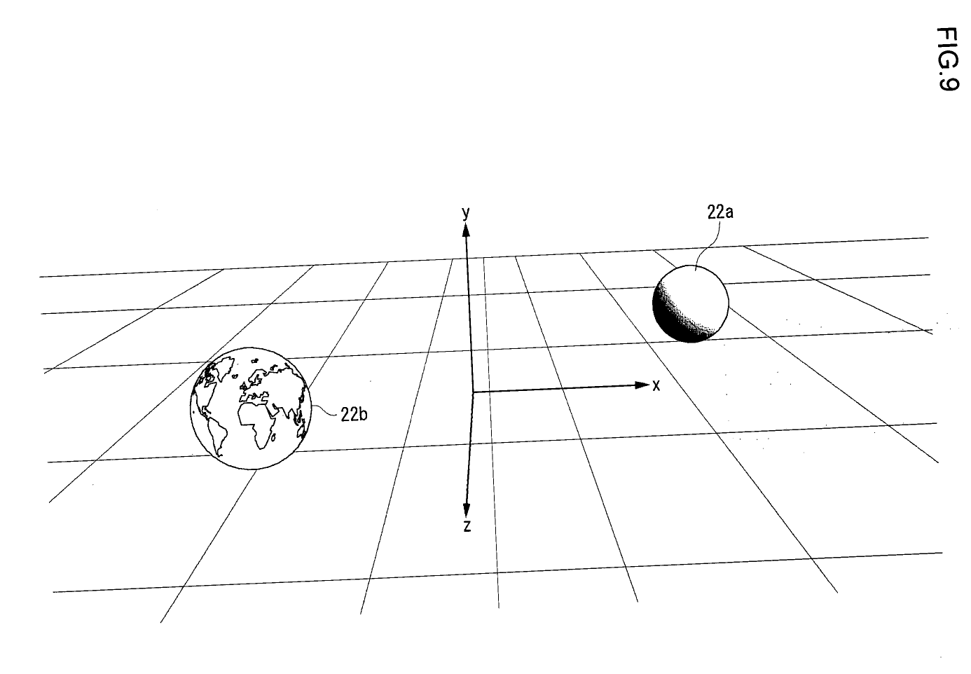

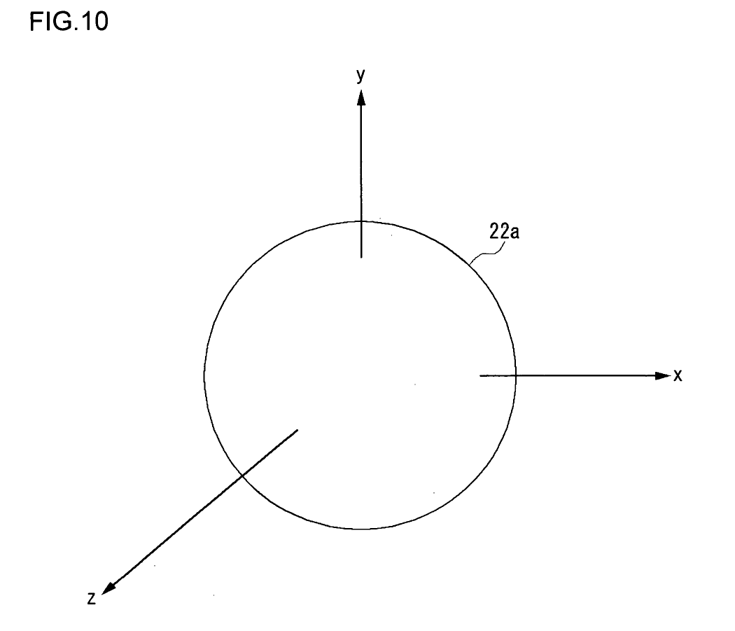

Now the components of the parallax control unit 114 will be described in detail. The object defining unit 128 defines objects in a virtual space based on inputted 3D data. FIG. 9 illustrates an arrangement of a first object 22a and a second object 22b on a world-coordinate system. FIG. 10 shows how a model coordinate system is set for the first object 22a. In a similar manner, another model coordinate system is set for the second object 22b. Normally, a model coordinate system is set such that the center of objects 22 is the origin.

The camera temporary positioning unit 130 temporarily positions a temporary camera in a virtual space on a world-coordinate system as shown in FIG. 9. This temporary camera is disposed so as to acquire the range of calculation region in the depth direction in an object space. As was mentioned earlier, this calculation region is a region where the visible surfaces of objects as seen from the temporary camera exist, that is, an area to be displayed three-dimensionally. On the other hand, the hidden surface region R2 is a region that is in back of the calculation region as seen from the temporary camera, where the invisible surfaces of objects hidden behind the visible surfaces thereof exist, that is, a region not to be displayed three-dimensionally. As was also mentioned earlier, according to the present embodiment, the range of calculation area in the depth direction is identified by a known algorithm of hidden surface removal which is called the z-buffer method.

With a three-dimensional image processing apparatus 100 according to the first embodiment, the range of calculation region in the depth direction can be identified by placing a temporary camera. And camera parameters for the real cameras are obtained by a method to be discussed later, based on the thus identified range of calculation area in the depth direction and the appropriate parallax for the user. The real cameras arranged in response to the thus obtained camera parameters generate viewpoint images, and a 3D display is produced based thereon. In this manner, a 3D display is achieved such that the previously obtained range of calculation region falls within the basic representation space, which is a space wherein the user has his/her appropriate parallax. Also, a 3D display which does not include hidden surface region in the basic representation space can be achieved by setting a calculation region in such a way as not to include the hidden surface region therein when obtaining camera parameters for the real cameras. Since the range of a basic representation space is limited, it is meaningful to exclude the hidden surface region, which the user cannot see in the first place, from the space. That is, temporarily placing a temporary camera and setting a calculation region beforehand allows the determination of camera parameters for the real cameras in such a way as to realize a 3D display that includes objects in the basic representation space.

The number of temporary cameras to be used may be one. While real cameras are used to generate viewpoint images, temporary cameras are used only to play the role of obtaining the range of calculation region in the depth direction. Therefore, a plurality of temporary cameras may be used, but it is possible to use only one temporary camera and obtain in a short time a maximum z-value and a minimum z-value that define the calculation region.

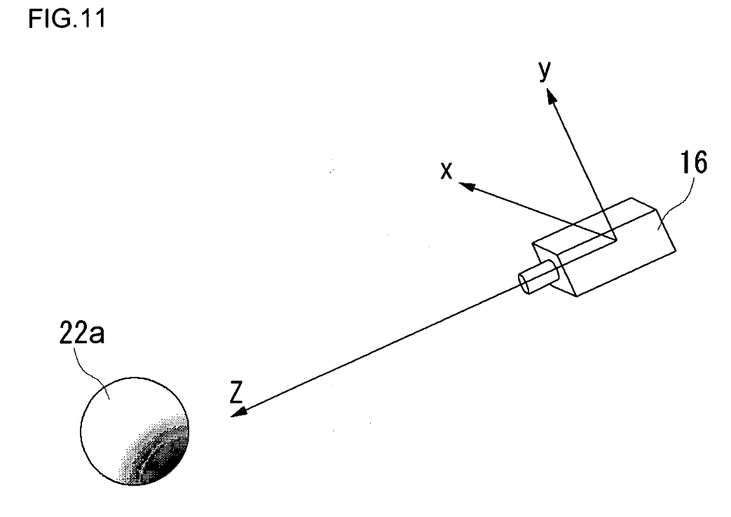

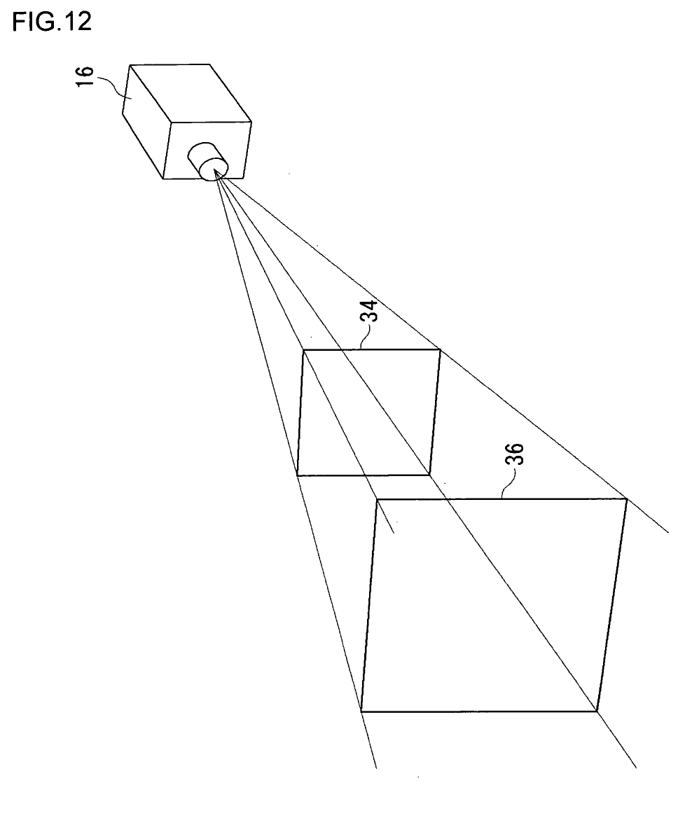

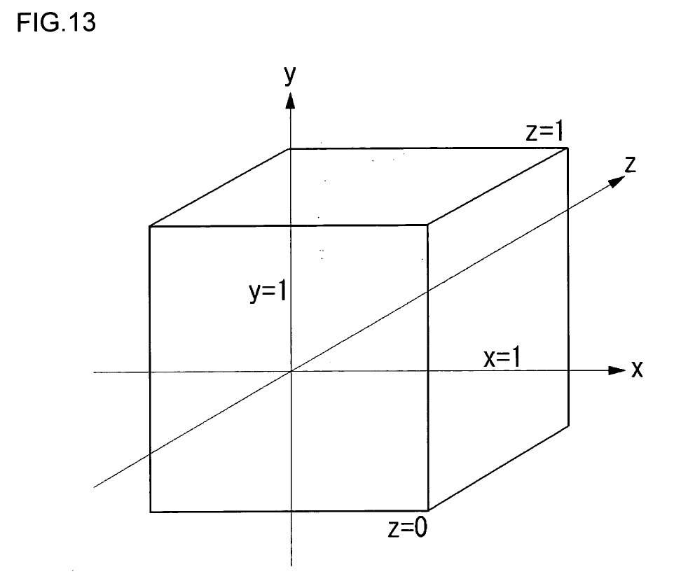

The coordinates conversion unit 132 converts the coordinates defined by the world-coordinate system into a perspective coordinate system. FIG. 11 shows a camera coordinate system. When the temporary camera 16 is set by the camera temporary positioning unit 130 at an arbitrary angle of view in an arbitrary direction at an arbitrary position of a world-coordinate system, a conversion to a camera coordinate system is done by the coordinates conversion unit 132. In the conversion like this from the world-coordinate system to the camera coordinate system, the whole thing is moved in parallel so that the temporary camera 16 lies at the origin and the camera coordinate system is rotated so that the sight line of the temporary camera 16 is oriented in the positive direction of Z axis. Affine transformation is used for this conversion. FIGS. 12 and 13 show perspective coordinate systems. As shown in FIG. 12, the coordinates conversion unit 132 performs clipping on a space to be displayed with a front projection plane 34 and a back projection plane 36. The front projection plane 34 and the back projection plane 36 are so determined by a user, for example, as to contain all visible objects. After the clipping, this view volume is converted into a rectangular parallelepiped as shown in FIG. 13. The processing in FIGS. 12 and 12 is called a projection processing also.

When a coordinate conversion has been done by the coordinates conversion unit 132, the z-value acquiring unit 134 acquires a range of calculation region in the depth direction in a virtual space containing objects to be displayed three-dimensionally, using the z-buffer method.

In the above example, the maximum z-value and the minimum z-value are obtained in pixel units, but the z-value acquiring unit 134 may obtain z-values at a resolution lower than that of viewpoint images generated by real cameras. That is, the maximum z-value and the minimum z-value may be obtained in sets of a plurality of pixels. The role of z-values to be obtained is to specify the range of calculation region for objects in the depth direction and therefore does not require the level of resolution needed in generating parallax images. Accordingly, lowering the resolution here than that for viewpoint images can reduce the amount of data processing for the acquisition of z-values, thus realizing a higher speed for 3D display processing as a whole.

The z-value acquiring unit 134 may also acquire z-values using objects to be displayed three-dimensionally and yet having smaller data amounts. The objects to be used in specifying a range of calculation region in the depth direction are not those actually displayed three-dimensionally. The accuracy required by them is low, and a certain level of accuracy suffices so long as it can specify a range of calculation region in the depth direction. Hence, use of objects having smaller data amounts in this manner can reduce the amount of data processing for the acquisition of z-values, thus realizing a higher speed for 3D display processing as a whole. In such a case, another object space may be prepared for the acquisition of z-values, and the z-values may be obtained by placing an object in this object space.

Where a part or the whole of an object has a penetrated or see-through area, z-values may be acquired by disregarding such an area. By doing so, a 3D display can be achieved in which the see-through areas are not included in the basic representation space. Since a basic representation space is limited as mentioned earlier, it is meaningful to exclude such penetrated or see-through areas in a part or the whole of an object, which the user cannot see in the first place, from the basic representation space. When an object having a see-through area in a part or the whole thereof is located in front of another object, failure to acquire z-values by disregarding such an area may sometimes result in a situation where the visible object behind the see-through area, which should be taken into consideration in the z-value acquisition, is not taken into consideration. Therefore, as mentioned above, it is meaningful to acquire z-values by excluding penetrated or see-through areas.

The camera placement determining unit 136 calculates camera parameters, such as camera interval, according to the z-values acquired by the z-value acquiring unit 134 and the appropriate parallax stored in the parallax information storage unit 120 and arranges two real cameras in the object space based thereon.

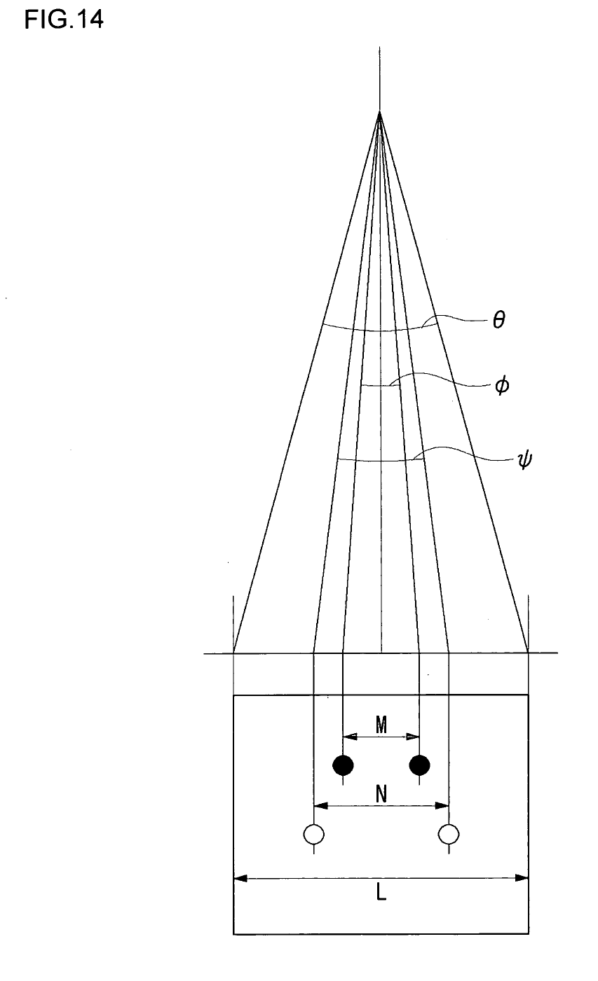

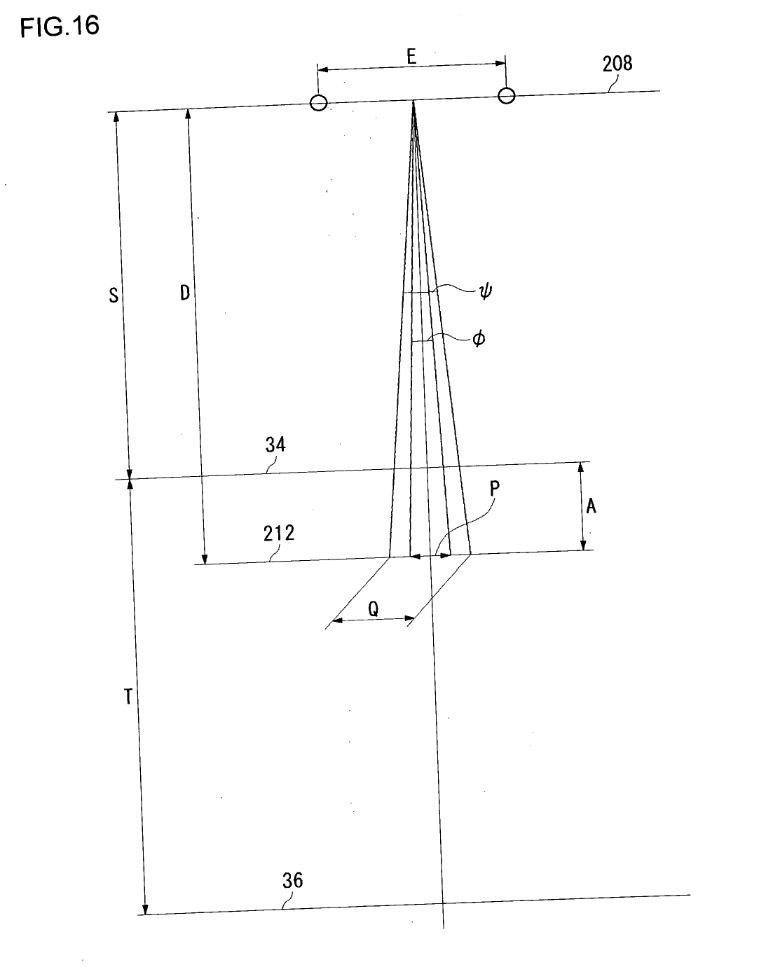

FIGS. 14 to 16 show processings in which the camera placement determining unit 136 according to the present embodiment determines parameters of real cameras based on z-values. FIG. 14 shows a relationship among a camera's angle of view, an image size and a parallax when the appropriate parallax is to be achieved. Firstly, limit parallaxes decided by the user by way of the three-dimensional sense adjusting unit 112 are converted into subtended angles of a temporary camera which is positioned temporarily. As shown in FIG. 14, the nearer-positioned and farther-positioned limit parallaxes can be denoted respectively by M and N, which are the numbers of pixels, and since the angle of view θ of the temporary camera corresponds to the number of horizontal pixels L of a display screen, a nearer-positioned maximum subtended angle φ and a farther-positioned maximum subtended angle φ, which are the subtended angles in the numbers of limit parallax pixels, can be represented using θ, M, N and L.
tan(+/2)=M tan(θ/2)/L
tan(φ/2)=N tan(θ/2)/L

In this manner, the nearer-positioned maximum subtended angle φ and the farther-positioned maximum subtended angle φ are determined based on the limit parallax given by the user.

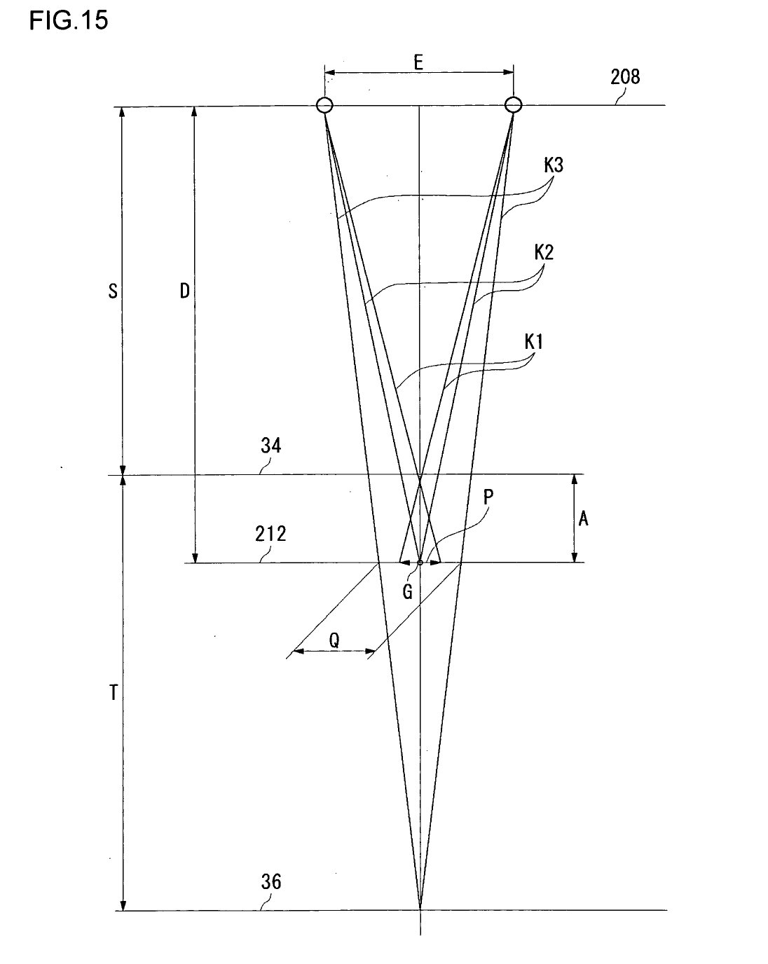

Next, how the parameters of the real cameras will be determined will be described hereinbelow. As described earlier, the basic representation space T (its depth is also denoted by T) shown in FIG. 15 is a space representing the range in which, the user assumes, the appropriate parallax is achieved and is determined via the three-dimensional sense adjusting unit 112. The distance from a plane, which is the front plane of the basic representation space T and which corresponds to the closeness that allows a point of position seen closest to a viewer, to a camera placement plane, namely, a viewpoint plane 208, is denoted by S. Here, the basic representation space T and the viewpoint distance S are determined based on the maximum z-value and the minimum z-value. That is, a difference between the maximum z-value and the minimum z-value is set as the basic representation space T whereas the minimum z-value is set as the viewpoint distance S. The basic representation space T and the viewpoint distance S may be determined based on a value close to the maximum z-value and a value close to the minimum z-value. This is because strict conditions are not required of the basic representation space T in the first place. In the present embodiment, there are two real cameras. That is, there are two viewpoints. And the distance from an optical axis intersecting plane 212 which is a surface that includes an intersecting position of optical axes thereof to the viewpoint plane 208 is denoted by D. The distance between the optical axis intersecting plane 212 and the front projection plane 34 is denoted by A.

Then, if the nearer-positioned and the farther-positioned limit parallax within the basic representation space T are denoted by P and Q, respectively, then
E:S=P:A
E:S+T=Q:T—A
holds. E is the distance between two real cameras. Now, point G, which is a pixel without parallax given, is positioned where the optical axes K2 from the both cameras intersect with each other on the optical axis intersecting plane 212, and the optical axis intersecting plane 212 is positioned at a screen surface. The beams of light K1 that produce the nearer-positioned maximum parallax P intersect on the front projection plane 34, and the beams of light K3 that produce the farther-positioned maximum parallax Q intersect on the back projection plane 36.

Similar to a case shown in FIG. 14, P and Q are expressed as follows by using φ and φ:
P=2(S+A)tan(φ/2)
Q=2(S+A)tan(φ/2)
As a result thereof,
E=2(S+A)tan(θ/2)·(SM+SN+TN)/(LT)
A=STM/(SM+SN+TN)
is obtained. Now, since S and T are calculated based on the maximum z-value and the minimum z-value and are known, A and E are automatically determined, thus automatically determining the optical axis intersection distance D and the distance E between cameras and determining the camera parameters. If the camera placement determining unit 136 determines the positions of cameras according to these parameters, then from here on, parallax images with an appropriate parallax can be generated and outputted by carrying out the processings of the projection processing unit 140 and the viewpoint image generator 141 independently for the images from the respective cameras. As has been described, E and A, which do not contain hardware information, realize a mode of representation not dependent on hardware.

In this manner, the camera placement determining unit 136 can arrange two different real cameras within a virtual space, based on the range of calculation region in the depth direction, namely, the maximum z-value and the minimum z-value, as acquired by the z-value acquiring unit 134, such that the temporary camera temporarily placed by the camera temporary positioning unit 130 comes to the center.

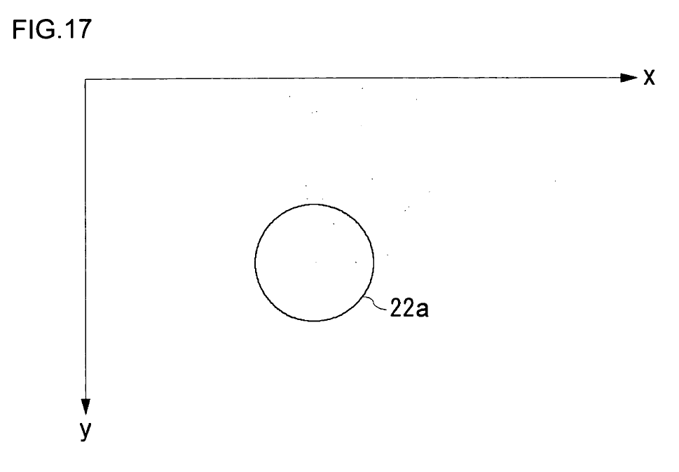

The origin moving unit 138 performs an origin movement such that the real cameras become the origin of the camera coordinate system. The projection processing unit 140 performs a projection processing as described above. In so doing, the positions of the front projection plane 34 and the back projection plane 36 in FIG. 12 may be determined by the minimum z-value and the maximum z-value, respectively. FIG. 17 illustrates a screen coordinate system. The viewpoint image generator 141 generates viewpoint images by performing a conversion processing into a screen coordinate system after a projection processing. The parallax image generator 142 generates parallax images based on a plurality of viewpoint images thus generated.

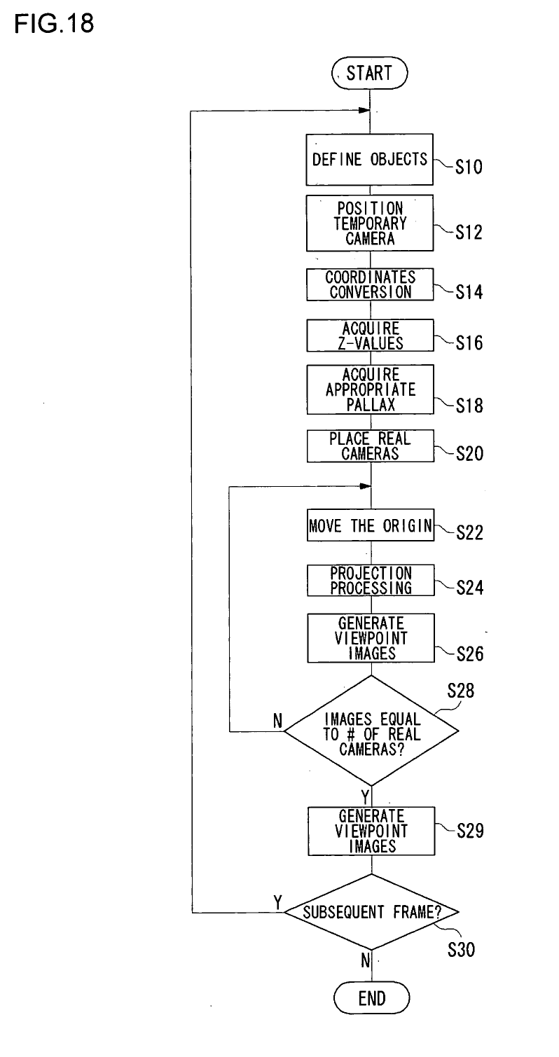

FIG. 18 shows a flow of processing by a three-dimensional image processing apparatus 100 according to the first embodiment of the present invention. An object defining unit 128 sets objects and a coordinate system in a virtual space based on inputted 3D data (S10). A camera temporary positioning unit 130 positions a temporary camera temporarily in an object space (S12). A coordinates conversion unit 132 converts coordinates defined on a world-coordinate system into those in a perspective coordinate system (S14). A z-value acquiring unit 134 acquires z-values, using the z-buffer method, to obtain a range of calculation region in the depth direction in a virtual space containing objects to be displayed three-dimensionally, thus obtaining a maximum z-value and a minimum z-value (S16).

A camera placement determining unit 136 acquires appropriate parallax stored in a parallax information storage unit 120 (S18). The camera placement determining unit 136 arranges two real cameras in the object space based on the maximum z-value and the minimum z-value and the appropriate parallax (S20).

An origin moving unit 138 performs an origin movement such that the real cameras become the origin of a camera coordinate system (S22). A projection processing unit 140 performs an above-described projection processing on objects to be displayed three-dimensionally (S24), and a viewpoint image generator 141 generates viewpoint images, which are two-dimensional images (S26). If viewpoint images equal to the number of cameras used have not yet been generated (N of S28), the processing from origin movement on is repeated. If viewpoint images equal to the number of cameras used have been generated (Y of S28), a parallax image generator 142 generates parallax images based on those viewpoint images (S29) and thus the processing of one frame is completed. If the processing is to be continued for a subsequent frame (Y of S30), the same processing as described above will be performed. If the processing is not to be continued (N of S30), the processing is terminated. Hereinabove, a flow of processing by a three-dimensional image processing apparatus 100 according to the first embodiment has been described.

### Second Embodiment

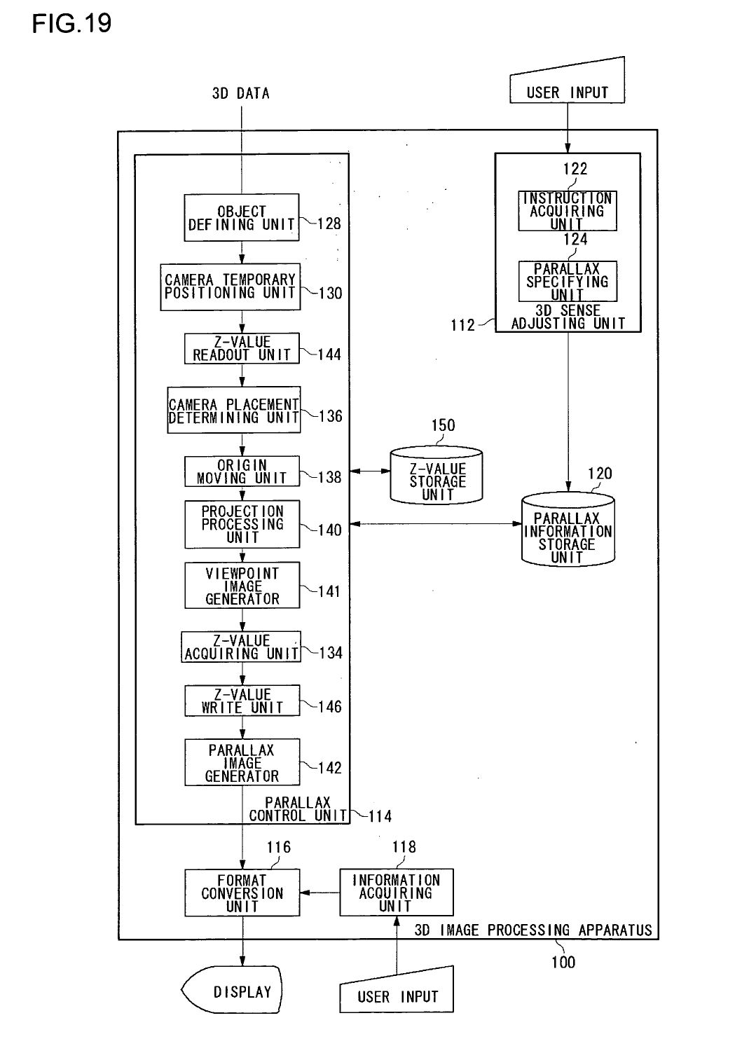

A second embodiment of the present invention will now be outlined hereinbelow. In the first embodiment, z-values are acquired by placing a temporary camera in an object space temporarily, but, according to the second embodiment, z-values acquired by real cameras are used. FIG. 19 illustrates a structure of a three-dimensional image processing apparatus 100 according to the second embodiment. Hereinbelow, the same reference numbers are used to indicate the same features and components as in the first embodiment, and the explanation thereof is omitted as appropriate. The three-dimensional image processing apparatus 100 according to the second embodiment includes components not found in the three-dimensional image processing apparatus 100 according to the first embodiment as shown in FIG. 4, namely, a z-value readout unit 144, a z-value write unit 146 and a z-value storage unit 150. The z-value storage unit 150 stores z-values acquired by a z-value acquiring unit 134. The z-values thus stored include at least a maximum z-value and a minimum z-value.

The z-value readout unit 144 reads out z-values of real cameras stored in the z-value storage unit 150. This z-value is a z-value which has been acquired by the real cameras in a frame immediately preceding the current frame. The z-value acquiring unit 134 may acquire z values of at least one real camera. When objects are substantially static, it is assumed that there is not much change in z values between a preceding frame and a current frame. According to the second embodiment, therefore, the z values of a preceding frame can be utilized as those of a current frame, which contributes to reducing the amount of processing in the acquisition of z values, thus realizing a higher speed for 3D image processing as a whole. This technique can also be applied when the objects are dynamic, because there is, in fact, not so much difference in movement of objects between a preceding frame and a current frame.

The z-value readout unit 144 may use combined z-values for two or more real cameras. “Combined” here means that of maximum z-values and minimum z-values obtained for their respective cameras, the largest maximum z-value is used as the new maximum Z value, and the smallest minimum z-value as the new minimum z-value. Combination of the z-values assures acquisition of more accurate z-values, and as a result, the real cameras can generate more effective parallax images. The z-value write unit 146 writes z-values acquired by the z-value acquiring unit 134 or z-values combined as described above in the z-value storage unit 150.

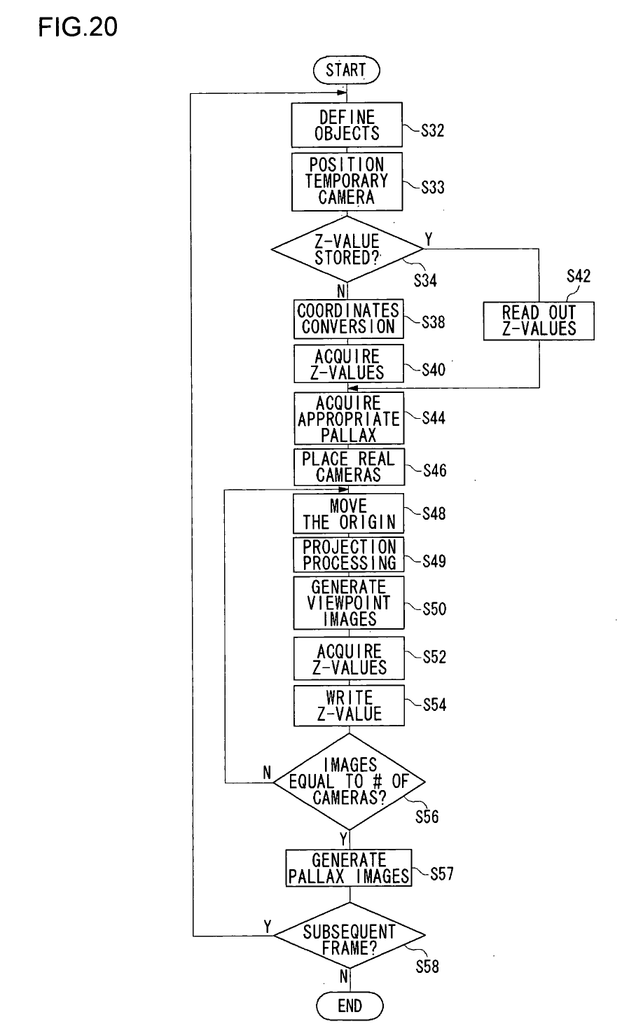

FIG. 20 shows a flow of processing by a three-dimensional image processing apparatus 100 according to the second embodiment of the present invention. An object defining unit 128 sets objects and a coordinate system in a virtual space based on inputted 3D data (S32). A camera temporary positioning unit 130 positions a temporary camera temporarily in the object space (S33). A z-value readout unit 144 refers to a z-value storage unit 150 and, if z-values for real cameras are stored there (Y of S34), reads out the z-values (S42). If z-values for real cameras are not stored there (N of S34), that is, if a processing for the first frame is to be initiated at the start of 3D image processing, a coordinates conversion unit 132 converts coordinates defined on a world-coordinate system into those on a perspective coordinate system (S38) A z-value acquiring unit 134 acquires z-values, using the z-buffer method, to obtain a range of calculation region in the depth direction in a virtual space containing objects to be displayed three-dimensionally, thus obtaining a maximum z-value and a minimum z-value (S40).

A camera placement determining unit 136 acquires appropriate parallax stored in a parallax information storage unit 120 (S44). The camera placement determining unit 136 arranges two real cameras in the object space based on the maximum z-value and the minimum z-value and the appropriate parallax (S46).

An origin moving unit 138 performs an origin movement such that the real cameras become the origin of a camera coordinate system (S48) A projection processing unit 140 performs an above-described projection processing on objects to be displayed three-dimensionally (S49), and a viewpoint image generator 141 generates viewpoint images, which are two-dimensional images (S50). At the time of generating viewpoint images, the z-value acquiring unit 134 acquires z-values for the real cameras using the z-buffer method (S52). A z-value write unit 146 writes the thus acquired z-values to the z-value storage unit 150 (S54). If viewpoint images equal to the number of cameras used have not yet been generated (N of S56), the processing from origin movement on is repeated. If viewpoint images equal to the number of cameras used have been generated (Y of S56), a parallax image generator 142 generates parallax images based on those viewpoint images (S57) and thus the processing of one frame is completed. If the processing is to be continued for a subsequent frame (Y of S58), the parallax image generating processing for the subsequent frame is performed. If the processing is not to be continued (N of S58), the parallax image generating processing is completed. Hereinabove, a flow of processing by a three-dimensional image processing apparatus 100 according to the second embodiment has been described.

### Third Embodiment

A third embodiment of the present invention will now be outlined hereinbelow. The second embodiment proves particularly effective for static objects. However, there may be cases where an object suddenly enters the field of view of a camera of this system or this three-dimensional image processing apparatus detects a scene change. In such a case, there occurs an abrupt change in the range of calculation region, so that it may be inappropriate to use the z-values acquired for the preceding frame as the z-values of the current frame. Then the three-dimensional image processing apparatus according to the third embodiment copes with such a situation by applying camera parameters, which generate parallax images with weaker parallax than that of the parallax images generated for the preceding frame, to the real cameras, instead of setting the camera parameters using the z-values for the preceding frame.

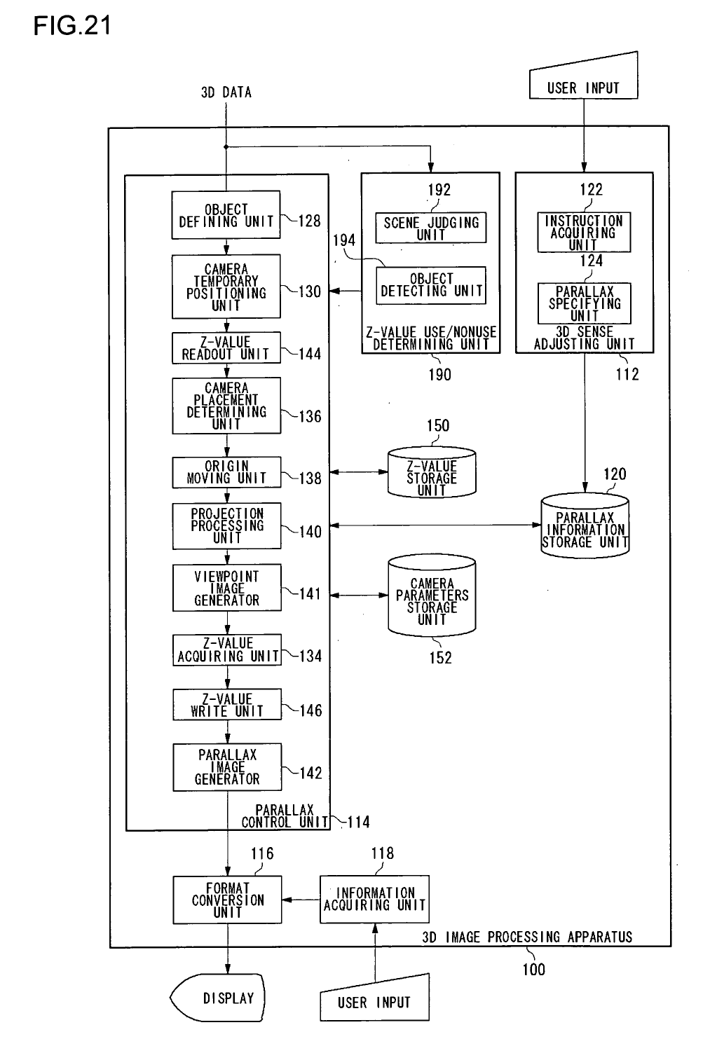

FIG. 21 illustrates a structure of a three-dimensional image processing apparatus 100 according to the third embodiment. Hereinbelow, the same reference numbers are used to indicate the same features and components as in the second embodiment, and the explanation thereof is omitted as appropriate. The three-dimensional image processing apparatus 100 according to the third embodiment includes components not found in the three-dimensional image processing apparatus 100 according to the second embodiment as shown in FIG. 19, namely, a z-value use/nonuse determining unit 190 and a camera parameters storage unit 152. In contrast to the camera placement determining unit 136 of FIG. 19, a camera placement determining unit 136 shown in FIG. 21 has an additional function of storing camera parameters for arranged real cameras frame by frame in the camera parameters storage unit 152.

The z-value use/nonuse determining unit 190 decides on use or nonuse of z-values and, when it decides on nonuse, conveys the nonuse of z-values to a parallax control unit 114. The z-value use/nonuse determining unit 190 is comprised of a scene judging unit 192 and an object detecting unit 194.

The scene judging unit 192 detects motion of objects by a known motion detecting method, such as a motion vector method. When it decides that there is much movement, the scene judging unit 192 detects a scene change and conveys nonuse of z-values to the parallax control unit 114.

The object detecting unit 194 detects the entry of another object into the object space. When it detects a momentary surpassing of a predetermined value by the difference between the maximum z-value and the minimum z-value, the object detecting unit 194 conveys nonuse of z-values to the parallax control unit 114.

When nonuse of z-values is instructed by the z-value use/nonuse determining unit 190, the camera placement determining unit 136 arranges the real cameras in such a manner as to generate parallax images with weaker parallax than that of the parallax images generated for the preceding frame. At this time, the camera placement determining unit 136 refers to a camera parameters storage unit 152 and sets a camera interval smaller than that used previously. The camera placement determining unit 136 may also refer to a camera parameters storage unit 152 and arrange the cameras by selecting camera parameters that realize the smallest camera interval. It may also arrange the cameras by using predetermined camera parameters.

When an abrupt change occurs in the range of calculation region, there may be cases where parallax images with larger parallax variation than those generated for the receding frame are generated. The user may sometimes feel discomfort viewing such parallax images. This problem may become more distinct when parallax images with too strong parallax are generated. To avoid such a problem, the three-dimensional image processing apparatus according to the third embodiment generates parallax images that realize weaker parallax than that of the parallax images generated for the preceding frame. As a result, a sudden variation in parallax is suppressed in 3D display, and the effect on the stereo vision of the user is lessened.

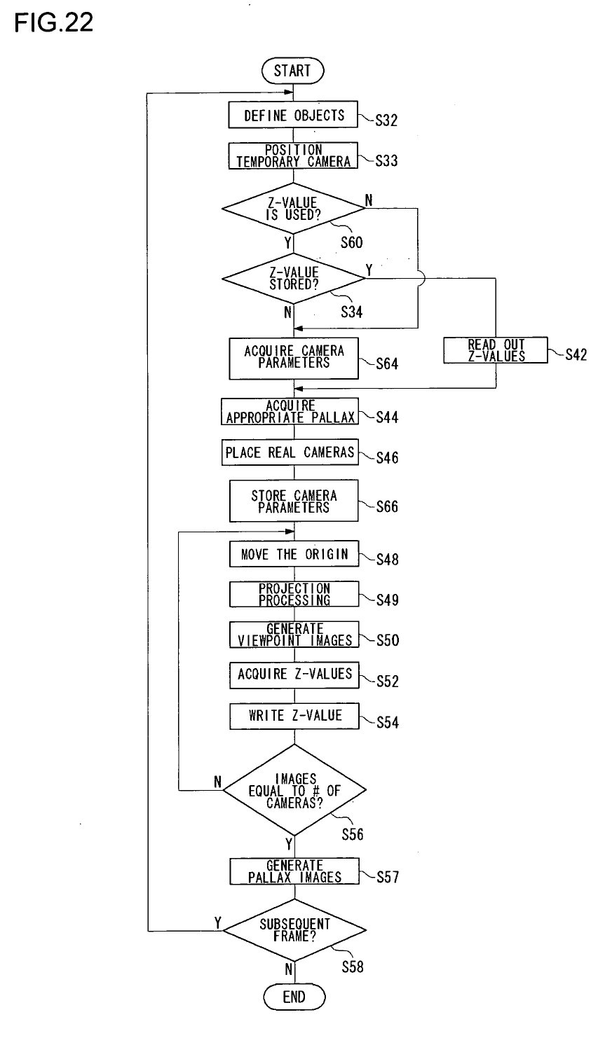

FIG. 22 shows a flow of processing by a three-dimensional image processing apparatus 100 according to the third embodiment of the present invention. An object defining unit 128 sets objects and a coordinate system in a virtual space (S32), and then a camera temporary positioning unit 130 positions a temporary camera temporarily in the object space (S33). A z-value use/nonuse determining unit 190 determines use or nonuse of z-values, and when it decides on the use of z-values (Y of S60), a z-value readout unit 144 refers to a z-value storage unit 150 (S34). Or if the z-value use/nonuse determining unit 190 decides on the nonuse of z-values (N of S60) or if z-values for real cameras are not stored (N of S34), a camera placement determining unit 136 refers to a camera parameters storage unit 152 and acquires camera parameters including a camera interval smaller than that used previously (S64). At this point, if a processing for the first frame is to be initiated at the start of 3D image processing, the camera placement determining unit 136 may use predetermined camera parameters.

The z-value readout unit 144 refers to the z-value storage unit 150 and, if z-values for real cameras are stored (Y of S34), reads out the z-values (S42) and skips the acquisition of camera parameters from the camera parameters storage unit 152. The camera placement determining unit 136 acquires appropriate parallax stored in a parallax information storage unit 120 (S44). The camera placement determining unit 136 arranges two real cameras in the object space based on the acquired camera parameters, if any, or on the maximum z-value and the minimum z-value and the appropriate parallax (S46).

The camera placement determining unit 136 stores camera parameters after the decision on the arrangement in the camera parameters storage unit 152 (S66). An origin moving unit 138 performs an origin movement such that the real cameras become the origin of a camera coordinate system (S48). A projection processing unit 140 performs an above-described projection processing on objects to be displayed three-dimensionally (S49), and a viewpoint image generator 141 generates viewpoint images, which are two-dimensional images (S50). At the time of generating viewpoint images, the z-value acquiring unit 134 acquires z-values for the real cameras using the z-buffer method (S52). A z-value write unit 146 writes the thus acquired z-values to the z-value storage unit 150 (S54). If viewpoint images equal to the number of cameras used have not yet been generated (N of S56), the processing from origin movement on is repeated.

If viewpoint images equal to the number of cameras used have been generated (Y of S56), a parallax image generator 142 generates parallax images based on those viewpoint images (S57) and thus the processing of one frame is completed. If the processing is to be continued for a subsequent frame (Y of S58), the parallax image generating processing for the subsequent frame is performed. If the processing is not to be continued (N of S58), the parallax image generating processing is terminated. Hereinabove, a flow of processing by a three-dimensional image processing apparatus 100 according to the third embodiment has been described.

Next, the structure according to the present embodiments will be described with reference to claim phraseology of the present invention by way of exemplary component arrangement. A “depth value acquiring unit” corresponds to the z-value acquiring unit 134. A “viewpoint placement unit” corresponds to the camera placement determining unit 136. A “parallax image generator” corresponds to the parallax image generator 142. A “viewpoint temporary positioning unit” corresponds to the camera temporary positioning unit 130. And a “depth value use/nonuse determining unit” corresponds to the z-value use/nonuse determining unit 190.

The present invention has been described based on the embodiments which are only exemplary. It is therefore understood by those skilled in the art that other various modifications to the combination of each component and process described above are possible and that such modifications are also within the scope of the present invention.

First Modification

In the first embodiment of the present invention, a temporary camera is used, as described above, to obtain z-values that may determine the arrangement of real cameras and not to generate viewpoint images. In contrast, a temporary camera in the first modified example can not only acquire z-values but also generate a viewpoint image which provides a basis for parallax images.

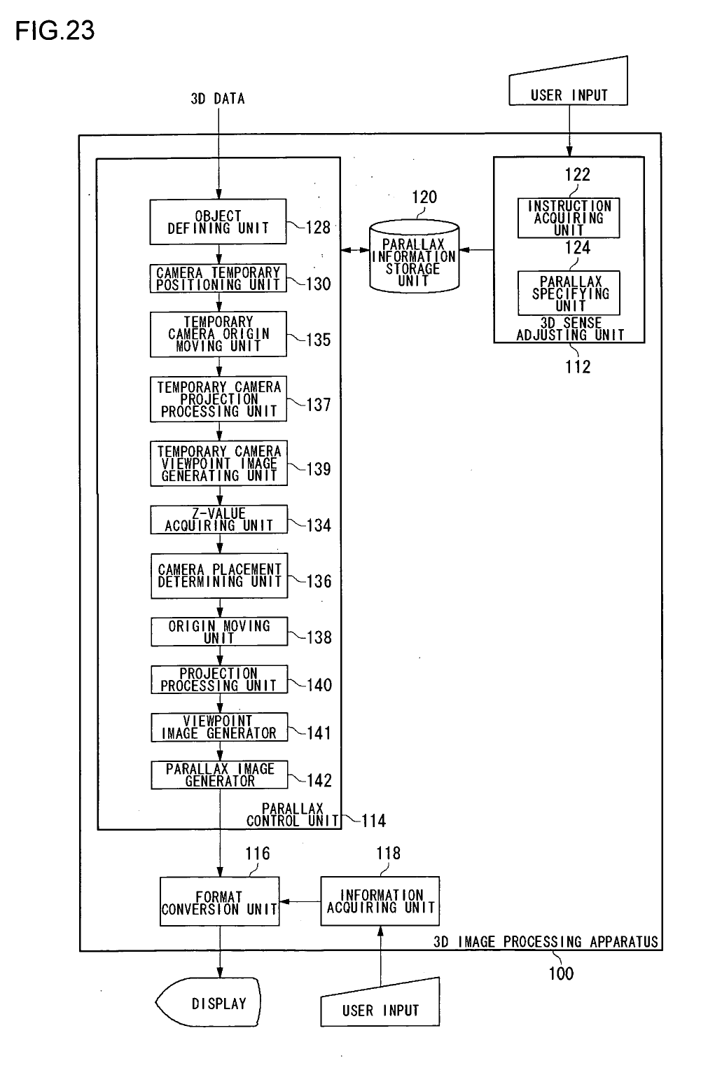

FIG. 23 illustrates a structure of a three-dimensional image processing apparatus 100 according to the first modification. Hereinbelow, the same reference numbers are used to indicate the same features and components as in the first embodiment, and the explanation thereof is omitted as appropriate. The three-dimensional image processing apparatus 100 according to the first modification excludes a coordinates conversion unit 132 from the three-dimensional image processing apparatus 100 according to the first embodiment as shown in FIG. 4, and newly includes components not found therein, namely, a temporary camera origin moving unit 135, a temporary camera projection processing unit 137 and a temporary camera viewpoint image generating unit 139.

The temporary camera origin moving unit 135 performs an origin movement such that the temporary camera becomes the origin of a camera coordinate system. The temporary camera projection processing unit 137 performs an above-described projection processing by the temporary camera on objects to be displayed three-dimensionally. And the temporary camera viewpoint image generating unit 139 generates a viewpoint image by performing a conversion processing into a screen coordinate system after the above-mentioned projection processing done by the temporary camera. As described above, in the first modified example, a temporary camera can generate a viewpoint image, so that the parallax image generator 142 can generate parallax images based not only on the viewpoint images generated by the real cameras but also on the viewpoint images generated by the temporary camera.

At this time, based on the acquired range of calculation region in the depth direction, a camera placement determining unit 136 arranges, in addition to a temporary camera which has been temporarily placed by a camera temporary positioning unit 130, two different real cameras in a virtual space such that the temporary camera comes to the center thereof. The camera placement determining unit 136 may arrange a plurality of real cameras at equal intervals on both sides outwardly of one temporary camera so that the temporary camera comes to the center the group of the real cameras.

Second Modification

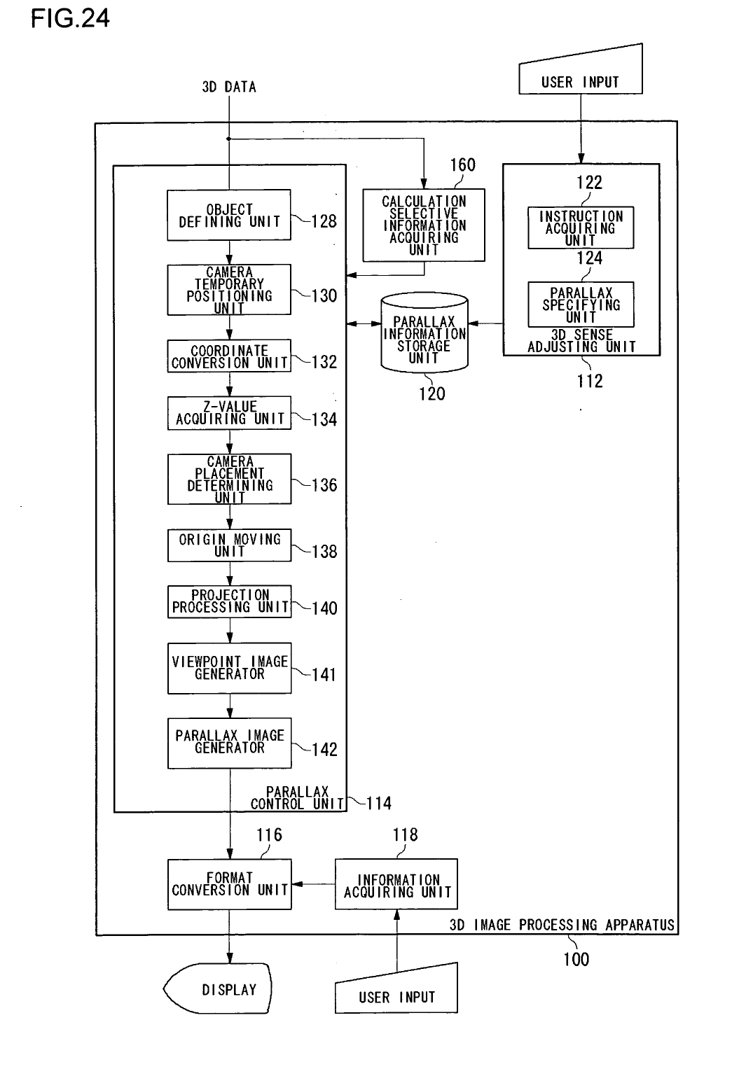

FIG. 24 illustrates a structure of a three-dimensional image processing apparatus 100 according to the second modification. In the second modified example, a calculation selective information acquiring unit 160 is newly added to the three-dimensional image processing apparatus 100 according to the first embodiment. The calculation selective information acquiring unit 160 acquires selective information for calculation to be included or not in the range of calculation regions related to the respective objects and reads the selective information for calculation. When an object having selective information for calculation not to be included in the range of calculation regions is acquired, the calculation selective information acquiring unit 160 instructs a z-value acquiring unit 134 to disregard the object and acquire z-values from the other object. Through this arrangement, an effective 3D display of an object can be achieved in which the object is intentionally made to fly out of the basic representation space. Also, it may be so arranged that a CPU, not shown, in the three-dimensional image processing apparatus 100 instructs the z-value acquiring unit 134 not to include a certain object in the range of calculation region or that the user gives such instructions using a GUI not shown. The z-value acquiring unit 134 acquires z-values, disregarding the object whose noninclusion is specified by the calculation selective information acquiring unit 160. Moreover, the calculation selective information acquiring unit 160 may be provided in a three-dimensional image processing apparatus 100 according to the second embodiment or the third embodiment.

Third Modification

According to the third embodiment, when the nonuse of z-values is indicated by the z-value use/nonuse determining unit 190, the real cameras are so positioned as to generate parallax images with weaker parallax than that of the parallax images generated for the preceding frame. In the third modified example, the parallax image generator 142 may generate a two-dimension image having no parallax when such an instruction as above is given. As already mentioned earlier, the major cause of a problem where the user feels discomfort viewing parallax images is due to the fact that parallax images with too strong parallax are generated. To avoid such a problem, the effect of such the stereo vision on user can be lessened by realizing a two-dimensional display, in the current frame, instead of a three-dimensional display. The structure of a three-dimensional image processing apparatus 100 according to the third modified example is the same as that of the three-dimensional image processing apparatus 100 according to the third embodiment. Similar to the above first modification, the temporary camera in the third modification can not only acquire z-values but also generate a viewpoint image which provides a basis for parallax images.

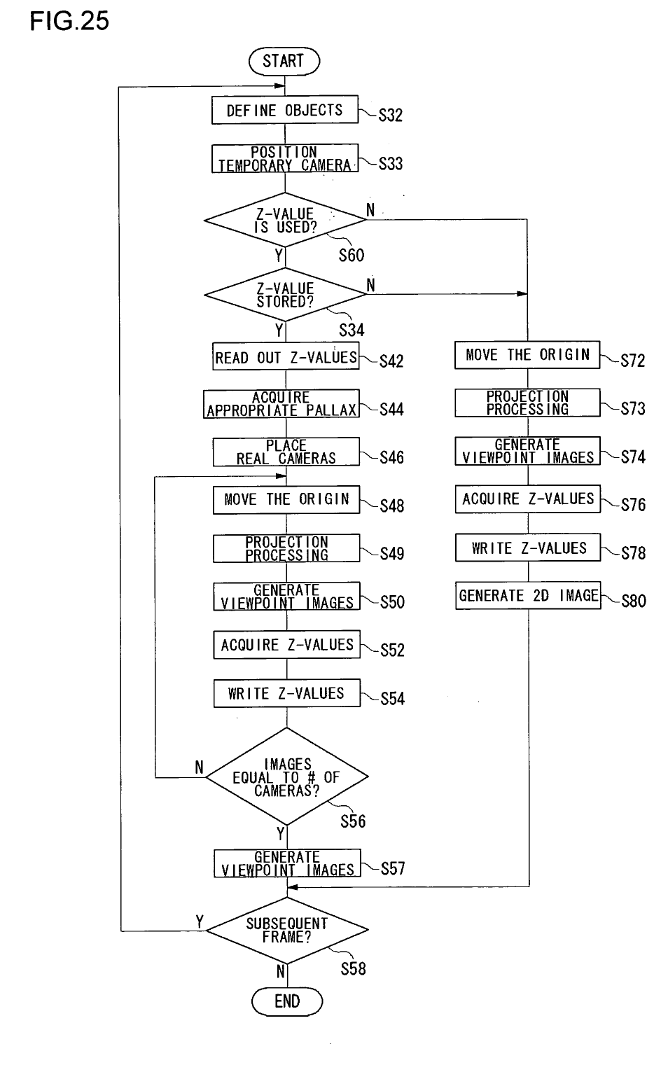

FIG. 25 shows a flow of processing by a three-dimensional image processing apparatus 100 according to the third modification. An object defining unit 128 sets objects and a coordinate system in a virtual space (S32). A camera temporary positioning unit 130 positions a temporary camera temporarily in the object space (S33). A z-value use/nonuse determining unit 190 determines use or nonuse of z-values, and when it decides on the use of z-values (Y of S60), a z-value readout unit 144 refers to a z-value storage unit 150 (S34). A processing to be done if the z-value use/nonuse determining unit 190 decides on the nonuse of z-values (N of S60) will be described hereinbelow. When it is decided by the z-value use/nonuse determining unit 190 that z-values be used (Y of S60), the z-value readout unit 144 refers to the z-value storage unit 150 and reads out z-values (S42) if the z-values of the real cameras are stored (Y of S34). And a processing to be done if z-values for real cameras are not stored (N of S34), that is, if a processing is at the start of 3D image processing and the first frame is to be processed will be described later.

A camera placement determining unit 136 acquires appropriate parallax stored in a parallax information storage unit 120 (S44). The camera placement determining unit 136 arranges two real cameras in the object space based on the maximum z-value, the minimum z-value and the appropriate parallax (S46).

An origin moving unit 138 performs an origin movement such that the real cameras become the origin of a camera coordinate system (S48). A projection processing unit 140 performs an above-described projection processing on objects to be displayed three-dimensionally (S49), and a viewpoint image generator 141 generates viewpoint images, which are two-dimensional images (S50). At the time of generating viewpoint images, the z-value acquiring unit 134 acquires z-values for the real cameras using the z-buffer method (S52). A z-value write unit 146 writes the thus acquired z-values to the z-value storage unit 150 (S54). If viewpoint images equal to the number of cameras used have not yet been generated (N of S56), the processing from origin movement on is repeated. If viewpoint images equal to the number of cameras used have been generated (Y of S56), a parallax image generator 142 generates parallax images based on those viewpoint images (S57) and thus the processing of one frame is completed.

When it is decided that z-values will not be used (N of S60), that is, when there occurs an abrupt change in the range of calculation region, or z-values for real cameras are not stored (N of S34), an origin moving unit 138 moves the temporary camera so that the temporary camera lies at the center of a camera coordinate system (S72). The projection processing unit 140 performs the above-described projection processing on objects to be displayed three-dimensionally (S73). The viewpoint image generator 141 generates viewpoint images, which are two-dimensional images (S74). The z-value acquiring unit 134 acquires z-values obtained by the temporary camera at the time when the viewpoint images were generated (S76). The z-value write unit 146 stores the thus acquired z-values in the z-value storage unit 150 (S78). The parallax image generator 142 does not generate parallax images but generates two-dimensional images having no parallax (S80) and completes the processing of one frame.

If the processing is to be continued for a subsequent frame (Y of S58), a processing for generating parallax images in a subsequent frame will be performed continuously. If the processing is not to be continued (N of S58), the processing is terminated. Hereinabove, a flow of processing by a three-dimensional image processing apparatus 100 according to the third modification has been described. In this manner, displaying the viewpoint images obtained by one temporary camera can realize the two-dimensional display.

Fourth Modification

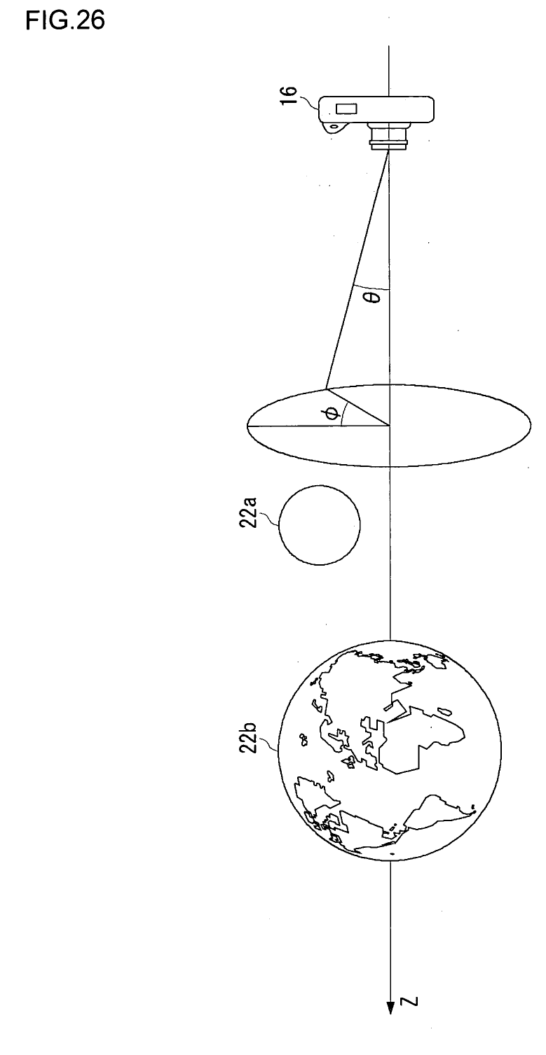

FIG. 26 schematically shows how a range of calculation region in the depth direction is acquired using angles. In the present embodiments, acquired are the z-values of an object located at a position corresponding to a pixel delimited by a segment in the X-axis direction and a segment in the Y-axis direction. In contrast thereto, according to the fourth modification, the maximum z-value and the minimum z-value may be obtained by acquiring z-values of objects that correspond equivalently to coordinates of points having the same first angle θ and the same second angle φ on a first object 22a and having also the same first angle θ and the same second angle φ on a second object 22b, as shown in FIG. 26. In so doing, another different virtual space for use with acquisition of z-values may be prepared so as to obtain the maximum z-value and the minimum z-value.

Fifth Modification

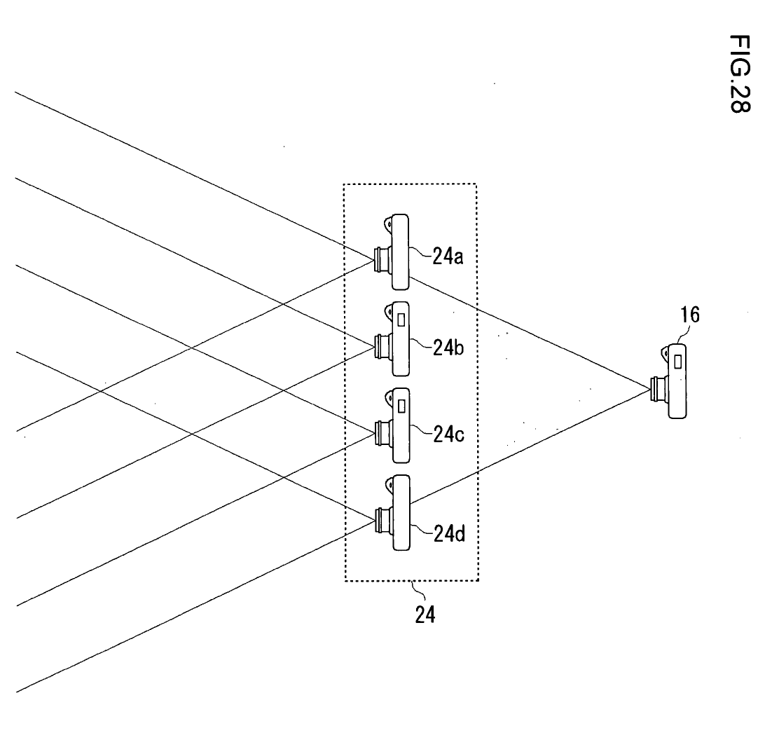

In the present embodiments, in the camera placement determining unit 136 the two real cameras are placed around a temporary camera which is the center thereof. According to the fifth modified example, a plurality of, for example four real cameras, are positioned. In this case of four real cameras altogether, two added real cameras are positioned away outwardly from each of the original two cameras at a distance equal to the distance between the original two cameras. FIG. 27 shows the positions of a four-eye camera system composed of four real cameras which are first to fourth real cameras 24a to 24d. The above-described A and E which were determined by between the two real cameras, namely, the second real camera 24b and the third real camera 24c which are located closer to the center may be used as the distance between other cameras. Thus, the time for calculating the camera parameters to determine the placement positions of the real cameras can be shortened and a higher speed for 3D display processing as a whole can be realized.

Sixth Modification

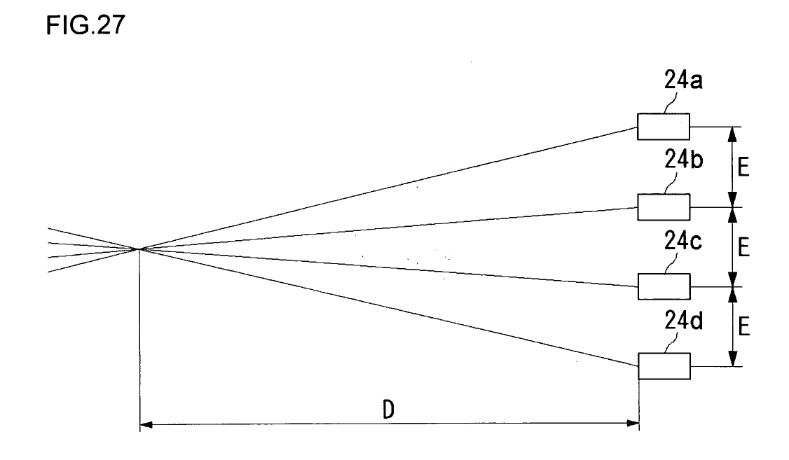

In the present embodiments, the camera temporary positioning unit 130 determines, frame by frame, the arrangement of a temporary camera in the virtual space. In the sixth modified example, however, the temporary camera may be so arranged as to contain the field of view of real cameras arranged by the camera placement determining unit 136. FIG. 28 shows a positional relationship among a temporary camera 16 and four real cameras comprised of first to fourth real cameras 24a to 24d. Referring to FIG. 28, the temporary camera 16 is arranged so that the field of view that contains the field of view of four real cameras, comprised of the first to fourth real cameras 24a to 24d, which are placed in the immediately preceding frame is realized.

Seventh Modification

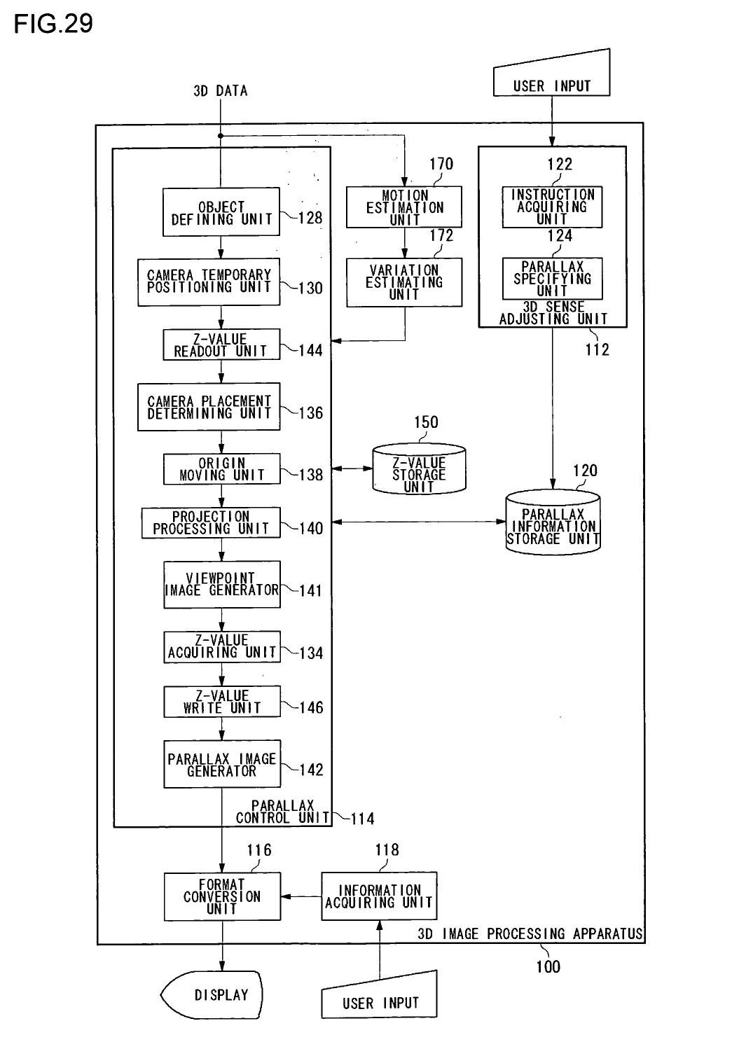

FIG. 29 illustrates a structure of a three-dimensional image processing apparatus 100 according to the seventh modification. In the seventh modified example, a motion estimation unit 170 and a variation estimating unit 172 are newly provided in the three-dimensional image processing apparatus 100 according to the second embodiment. The motion estimation unit 170 detects the motions in the front and back direction of each object, the acting speed thereof and the like, and estimates a state of future motion of the objects based on the detected results. The variation estimating unit 172 estimates, based on the estimated results obtained by the motion estimation unit 170, a variation of a predetermined region that contains objects to be three-dimensionally displayed. For example, the variation estimating unit 172 adds this variation to the range of calculation region in the depth direction in the immediately preceding frame, so that the range of calculation region in the depth direction in the current frame can be estimated. In so doing, z-values may be acquired based on the range of calculation region in the depth direction, so that they may serve as estimated values of z-values in the current frame. The variation estimating unit 172 can also estimate camera parameters, such as camera intervals or optical axis intersecting positions with which to realize an arrangement of cameras according to this variation.

A camera placement determining unit 136 determines the placement positions of real cameras in a virtual space, based on the range of calculation in the depth direction or estimated result on the camera parameters obtained from the variation estimating unit 172. For example, when an estimated result where the range of calculation region in the depth direction would be considerably enlarged is obtained by the variation estimating unit 172, the camera placement determining unit 136 arranges the real cameras in a manner such that the camera intervals between the real cameras are small. The camera placement determining unit 136 may adjust optical axis intersecting positions of the real cameras in accordance with the change in the estimated result, obtained by the variation estimating unit 172, of the range of calculation region in the depth direction. For example, the camera placement determining unit 136 may arrange the real cameras by so adjusting the optical axis intersecting positions that ratio of a distance between the closest calculation region plane 18 and the optical axis intersecting position and the distance between the optical axis intersecting position and the farthest calculation region plane 20 remains constant. As a result, the arrangement of the real cameras can be realized in accordance with the motion of objects and therefore the three-dimensional image processing apparatus 100 can obtain further highly accurate viewpoint images.

Eighth Modification

According to the third embodiment, when it is determined by the z-value use/nonuse determining unit 190 that z-values will not be used, the parallax images with weaker parallax than that of the parallax images generated for the preceding frame are generated in the current frame. In the eighth modified example, when it is determined by the z-value use/nonuse determining unit 190 that z-values will not be used, the z-value acquiring unit 134 may acquire the range of calculation region in the depth direction by use of the front projection plane 34 and the back projection plane 36 which are temporarily set at the time of the above-described clipping processing, without using the z-values acquired in the immediately preceding frame. As described earlier, since the front projection plane 34 and the back projection plane 36 are so determined in the first place as to contain all visible objects therein, it is effective to use a region surrounded by the front projection plane 34 and the back projection plane 36 as a calculation region containing objects to be three-dimensionally displayed.

Ninth Modification

According to the third embodiment, when it is determined by the z-value use/nonuse determining unit 190 that z-values will not be used, the parallax images with weaker parallax than that of the parallax images generated for the immediately preceding frame are generated in the current frame. When the viewpoint images are generated and at the same time the z-values are acquired by the real cameras, the three-dimensional image processing will be less problematic in terms of time. However, when a processing for acquiring z-values needs to be done at another occasion aside from the generation of viewpoint images, a high-speed processing must be attempted with a simplified acquisition method. In such a case, according to the ninth modified example the z-values may be obtained at a resolution lower than that of viewpoint images. As described earlier, the role of z-values is to identify the range of calculation region for objects in the depth direction and therefore does not require the level of resolution needed in generating parallax images. Accordingly, the use of a resolution here lower than that for viewpoint images can reduce the amount of data processing for the acquisition of z-values, thus realizing a high speed for 3D display processing as a whole. If the processing for acquiring z-values by the z-value acquiring unit 134 cannot be completed by the timing of the scene change, the scene change may be delayed until this acquisition processing will have been completed.

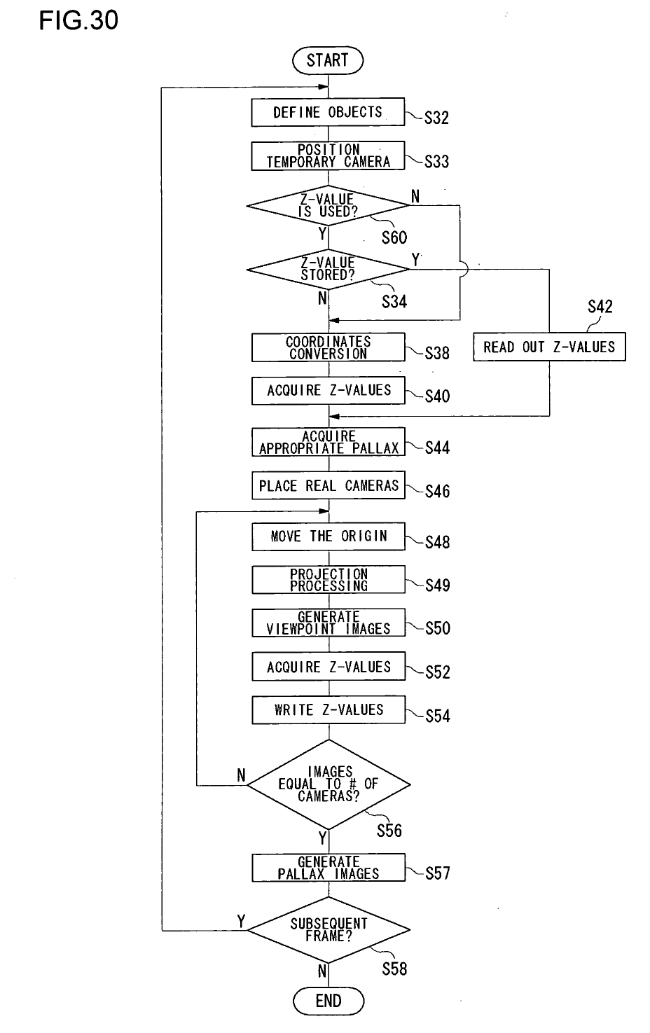

FIG. 30 shows a flow of processing by a three-dimensional image processing apparatus 100 according to the ninth modification. After an object defining unit 128 sets objects and a coordinate system in a virtual space (S32), a camera temporary positioning unit 130 positions a temporary camera temporarily in the object space (S33). A z-value use/nonuse determining unit 190 determines use or nonuse of z-values, and when it decides on the use of z-values (Y of S60), a z-value readout unit 144 refers to a z-value storage unit 150 (S34).

When it is decided that z-values will not be used (N of S60) or when z-values for real cameras are not stored in the z-value storage unit 150 (N of S34), a coordinates conversion unit 132 converts coordinates defined on a world-coordinate system into those on a perspective coordinate system (S38). A z-value acquiring unit 134 acquires z-values, using the z-buffer method, to obtain a range of calculation region in the depth direction in a virtual space containing objects to be displayed three-dimensionally, thus obtaining a maximum z-value and a minimum z-value (S40). At this time, as described above, the z-value acquiring unit 134 may acquire the z-values at a resolution lower than that of viewpoint images. If the processing for acquiring z-values by the z-value acquiring unit 134 cannot be completed by the timing of the scene change, the scene change may be delayed until this acquisition processing will have been completed.

When z-values are stored in the z-value storage unit 150, the z-value readout unit 144 reads out the z-values (S42). A camera placement determining unit 136 acquires appropriate parallax stored in a parallax specifying unit 124 (S44). The camera placement determining unit 136 places two real cameras in the object space based on the maximum z-value, the minimum z-value and the appropriate parallax (S46).

An origin moving unit 138 performs an origin movement such that the real cameras become the origin of a camera coordinate system (S48). A projection processing unit 140 performs the above-described projection processing on objects to be displayed three-dimensionally (S49), and a viewpoint image generator 141 generates viewpoint images, which are two-dimensional images (S50). At the time of generating the viewpoint images, the z-value acquiring unit 134 acquires z-values for the real cameras using the z-buffer method (S52). A z-value write unit 146 writes the thus acquired z-values to the z-value storage unit 150 (S54).

If viewpoint images equal to the number of cameras used have not yet been generated (N of S56), the processing from origin movement on is repeated. If viewpoint images equal to the number of cameras used have been generated (Y of S56), a parallax image generator 142 generates parallax images based on those viewpoint images (S57) and thus the processing of one frame is completed. If the processing is to be continued for a subsequent frame (Y of S58), the parallax image generating processing for the subsequent frame is performed continuously. If the processing is not to be continued (N of S58), the parallax image generating processing is terminated. Hereinabove, a flow of processing by a three-dimensional image processing apparatus 100 according to the ninth modification has been described.

Tenth Modification

Although the cameras are placed horizontally relative to the screen surface according to the present embodiments, they may be placed vertically and the same effect as in the horizontal direction can be enjoyed.

Eleventh Modification

The z-values of objects are acquired using the z-buffer method in the present embodiments. As a modified example, a depth map may be acquired so as to identify a range of calculation area in the depth direction. In this modified example, the same advantageous effect as in the present embodiments can be achieved.

Twelfth Modification

Any arbitrary choice of combination among the first to third embodiments may be effective. According to this modified example, advantageous effects achieved by combining the first to third embodiments in any arbitrary manner will be gained.

Although the present invention has been described by way of exemplary embodiments and modified examples, it should be understood that many other changes and substitutions may further be made by those skilled in the art without departing from the scope of the present invention which is defined by the appended claims.

1. A three-dimensional image processing apparatus that displays an object three-dimensionally based on a plurality of viewpoint images corresponding to different viewpoints, the apparatus comprising:
a depth value acquiring unit which acquires a range of calculation region in a depth direction in a virtual space that contains the object to be displayed three-dimensionally;
a viewpoint placement unit which places a plurality of different viewpoints in the virtual space based on the acquired range of calculation region in the depth direction; and
a parallax image generator which generates parallax images based on viewpoint images from the plurality of different viewpoints.

2. A three-dimensional image processing apparatus according to claim 1, further comprising a viewpoint temporary positioning unit which temporarily positions at least one viewpoint in the virtual space, wherein said depth value acquiring unit acquires the range of calculation region in the depth direction based on the temporarily positioned viewpoint.

3. A three-dimensional image processing apparatus according to claim 2, wherein said viewpoint temporary positioning unit positions one viewpoint in the virtual space.

4. A three-dimensional image processing apparatus according to claim 2, wherein said viewpoint temporary positioning unit positions the plurality of different viewpoints in the virtual space in such a manner as to have a field of view that contains a field of view of the plurality of different viewpoints placed by said viewpoint placement unit.

5. A three-dimensional image processing apparatus according to claim 3, wherein said viewpoint temporary positioning unit positions the viewpoint in the virtual space in such a manner as to have a field of view that contains a field of view of the plurality of different viewpoints placed by said viewpoint placement unit.

6. A three-dimensional image processing apparatus according to claim 2, wherein based on the range of calculation region in the depth direction acquired by the depth value acquiring unit said viewpoint placement unit places, in addition to the at least one viewpoint temporarily positioned by said viewpoint temporary positioning unit, two different viewpoints in the virtual space such that the viewpoint positioned by said viewpoint temporary position unit comes to a center of the two different viewpoints placed by said viewpoint placement unit.

7. A three-dimensional image processing apparatus according to claim 6, wherein said viewpoint positioning unit places a plurality of viewpoints on both sides outwardly of the two different viewpoints so that a distance between viewpoints is equal to an interval between the two different viewpoints.

8. A three-dimensional image processing apparatus according to claim 1, wherein said depth value acquiring unit acquires the range of calculation region in the depth direction at a resolution lower than that of the viewpoint images.

9. A three-dimensional image processing apparatus according to claim 1, wherein said depth value acquiring unit acquires the range of calculation region in the depth direction, by using an object which corresponds to the object to be displayed three-dimensionally and which has a small amount of data.

10. A three-dimensional image processing apparatus according to claim 1, wherein said depth value acquiring unit acquires the range of calculation region in the depth direction from at least one viewpoint among the plurality of viewpoints placed by said viewpoint placement unit.

11. A three-dimensional image processing apparatus according to claim 1, wherein said depth value acquiring unit acquires ranges of calculation region in depth directions from at least two viewpoints among the plurality of viewpoints placed by said viewpoint placement unit and generates one range of calculation region in the depth direction by combining the ranges of calculation region in the respective depth directions.

12. A three-dimensional image processing apparatus according to claim 10, further comprising a depth value use/nonuse determining unit which determines whether the range of calculation region acquired by said depth value acquiring unit can be used or not, wherein when it is decided by said depth value use/nonuse determining unit that the range of calculation region cannot be used, said parallax image generator generates a two-dimensional image having no parallax.

13. A three-dimensional image processing apparatus according to claim 10, further comprising a depth value use/nonuse determining unit which determines whether the range of calculation region in the depth direction acquired by said depth value acquiring unit can be used or not, wherein when it is decided by said depth value use/nonuse determining unit that the range of calculation region in the depth direction cannot be used, said viewpoint placement unit arranges the plurality of different viewpoints in such a manner as to generate parallax images with weaker parallax than that of the parallax images generated previously.

14. A three-dimensional image processing apparatus according to claim 10, further comprising a depth value use/nonuse determining unit which determines whether the range of calculation region in the depth direction acquired by said depth value acquiring unit can be used or not, wherein when it is decided by said depth value use/nonuse determining unit that the range of calculation region in the depth direction cannot be used, said depth value acquiring unit acquires the range of calculation region in the depth direction, using a front projection plane and a back projection plane.

15. A three-dimensional image processing apparatus according to claim 10, further comprising:
a motion estimation unit which detects a motion state of the object and estimates a state of future motion of the object based on a detected result; and
a variation estimating unit which estimates, based on the motion state of the object estimated by said motion estimation unit, a variation of a predetermined region that contains the object,
wherein said viewpoint placement unit arranges the plurality of different viewpoints in the virtual space, based on the variation of a predetermined region estimated by said variation estimating unit.

16. A three-dimensional image processing apparatus according to claim 1, further comprising a calculation selective information acquiring unit which acquires selective information for calculation to be included or not in the range of calculation region for each object, wherein when the selective information for calculation not to be included in the range of calculation region is acquired by said calculation selective information acquiring unit, said depth value acquiring unit disregards an object which is decided not to be included and acquires a range of calculation region in the depth direction from another object.

17. A three-dimensional image processing apparatus according to claim 2, further comprising a calculation selective information acquiring unit which acquires selective information for calculation to be included or not in the range of calculation region for each object, wherein when the selective information for calculation not to be included in the range of calculation region is acquired by said calculation selective information acquiring unit, said depth value acquiring unit disregards an object which is decided not to be included and acquires a range of calculation region in the depth direction from another object.

18. A three-dimensional image processing apparatus according to claim 10, further comprising a calculation selective information acquiring unit which acquires selective information for calculation to be included or not in the range of calculation region for each object, wherein when the selective information for calculation not to be included in the range of calculation region is acquired by said calculation selective information acquiring unit, said depth value acquiring unit disregards an object which is decided not to be included and acquires a range of calculation region in the depth direction from another object.

19. A method for processing three-dimensional images, the method including:
acquiring a range of calculation region in a depth direction in a virtual space that contains an object to be displayed three-dimensionally;
placing a plurality of different viewpoints in the virtual space based on the acquired range of calculation region in the depth direction; and
generating parallax images based on viewpoint images from the plurality of different viewpoints.
